(19) United States
(12) Patent Application Publication
(10) Pub. No.: US 2006/0289115 A1
(43) Pub. Date: Dec. 28, 2006

(54) Method for bonding two solid planes via surface assembling of active functional groups

(75) Inventors: Jianying Zhao, Jilin Province (CN); Xuepeng Qiu, Jilin Provice (CN); Lianxun Gao, Jilin Provice (CN); Zheng Bian, Jilin Province (CN)

Correspondence Address: DICKSTEIN SHAPIRO LLP, 1177 AVENUE OF THE AMERICAS (6TH AVENUE), NEW YORK, NY, 10036-2714, US

(73) Assignee: CHANGCHUN INSTITUTE OF APPLIED CHEMISTRY CHINESE ACADEMY OF SCIENCE

(21) Appl. No.: 11/453,067

(22) Filed: Jun. 15, 2006

(30) Foreign Application Priority Data
Jun. 22, 2005 (CN) 200510016908.2

(51) Int. Cl. C04B 37/00

(52) U.S. Cl. 156/325

(57) ABSTRACT

The present invention belongs to a bonding technical field of biochips or micromechanical electrical devices, more specifically, to a novel method for bonding two solid planes containing silicon, oxygen, metal or other elements at a moderate temperature via surface assembling of active functional groups. The method includes the steps of: (1) cleaning and hydroxylating solid planes of silicon plate, quartz or glass; (2) aminating a hydroxylated surfaces of the substrate; (3) forming a mono-layer or multi-layer assembled film with compound monomers having an active bi-functional or multi-functional group on an aminated substrate surface; and (4) contacting two solid planes with a assembled film having the same or different active functional groups on its surface tightly, and forming covalent bonds at an appropriate temperature, pressure and a vacuum degree. Thus two solid planes are bonded with assembled films of bi-functional molecule or multi-functional molecule, thereby a bonding at molecular level of two solid planes are achieved.

### TECHNICAL FIELD

The present invention belongs to a bonding technical field of biochips or micro electromechanical devices.

### BACKGROUND ART

Biochip technique is a core technique of portable biochemical analyzer. The substrate of a chip is etched into various microchannel networks with a micron structure or an array structure by micromachining technique, thereafter a chemical modification is carried out on the surface thereof such that functional groups with biochemical activities such as hydroxyl, amino, aldehyde group or the like are formed on the surface. These functional groups can be used to bond biochemical macromolecules such as enzymes, proteins, antigens-antibodies, biotins or the like, or other biochemical reagents, such that thousands upon thousands life-relating datum are integrated on a chip about several cm². Various biochemical reactions involved by life science and medicine can be carried out by using biochips; thereby the objects for analyzing and testing genes, antigens, living cells and the like can be achieved. The ultimate object of the development of biochips is to integrate all the biochemical assay process from the preparation of samples and chemical reactions to analysis and detections, thereby obtaining so-called “micro total analytical system” or “laboratory on a chip”. The machining of biochips refer to some well-developed micromachining techniques in microelectronics industry and other machining industries, and the micro-structures having a size of micron order for separating and reacting bio-samples are machined on a base material of glass, plastic or silicon wafer and the like, thereafter the micro-structures are subjected to a necessary surface chemical treatment, and the desired biochemical reactions and assays are performed.

The current method for preparing micro-flow control analytical chips is usually divided into two steps: a first step of fabricating microchannel networks on a substrate, and a second step of bonding the substrate and a cover to form an integrated microchip. The bonding request that the substrate has sufficient bonding strength with the cover, the channel networks are completely sealed, and the microchannels are prevent from transformation and blocking, therefore, the bonding becomes one of the key techniques for preparing a micro-flow control analytical chip with good properties.

In the view of the current methods for preparing micro-flow control analytical chips, one commonly used is thermal-bonding, wherein a glass material is generally melt-bonded in a high temperature oven (Zhonghui H. Fan, Micromachining of Capillary Electrophoresis Injectors and Separators on Glass Chips and Evaluation of Flow at Capillary Intersections., Anal. Chem.; 1994; 66(1); 177-184.), under a temperature up to 650° C. The bonding temperature of a quartz chip is above 1000° C. (Stephen C.; Fused Quartz Substrates for Microchip Electrophoresis., Anal. Chem.; 1995; 67(13); 2059-2063). In order to achieve a relatively desirable bonding effect, the ambience for bonding must have certain cleanness, and the substrate must have a preferable flatness. An anode bonding method (A. Honneborg et al., Silicon to silicon anodic bonding with a borosilicate glass layer, J. Micromech. Microeng., vol. 1 (1991) 139-144.) is a bonding method wherein a layer of film material such as polysilicon, silicon nitride and the like as an intermediate layer is deposited on the glass surfaces of two glass plates, a voltage of about 700-1200 V is applied between the two glass plates, and the temperature is raised to 400° C. so as to achieve the bonding of two glass substrates. Although the bonding temperature in this method is lowered significant, it still belongs to high temperature bonding. As to the polymer materials, their glass transition temperatures and/or melting points are relatively low; the thermal-bonding temperatures are also relatively low, being usually around the glass transition temperatures of the polymers. It is only need to keep the substrate coincide with the cover and hold them tightly, and place it into a high temperature oven for a period of time when the bonding is carried out. As to a method by using a polymer binder, which has a simple operation, low bonding temperature and high bonding strength, however, it is found by experiments that with this method, the microchannels are readily transformed, even blocked. Thermal-bonding process is relatively well-established, with a higher bonding strength and a longer life of chip, thus it is more frequently used in an ordinary production. However, the common high temperature bonding method will impart a certain influence to the microchannels networks on a substrate, the probability of successful bonding is low, and it is unsuitable for some thermal-sensitive materials or devices.

As a conventional material for preparing micro-flow control analytical chips, glass or quartz substrates are superior in optical properties and their micro-machining processes are well-established, but their further applications are limited by the conventional high temperature bonding technique. Using a low temperature bonding process such as ultraviolet curing process (Xu, N., Lin, Y., A Microfabricated Dialysis Device for Sample Cleanup in Electrospray Ionization Mass Spectrometry., Anal. Chem. 1998, 70, 3553-3556); (Xiang, F., An Integrated Microfabricated Device for Dual Microdialysis and On-Line ESI-Ion Trap Mass Spectrometry for Analysis of Complex Biological Samples., Anal Chem. 1999, 71, 1485-1490.), bonding the glass chips by a binder under room temperature, can prevent the binder from diffusing into the microchannels. Specifically, a thin layer of binder is generally coated on a silicon plate, and the glass substrate with etched microchannels is placed carefully onto the silicon plate, and separated as soon as the space between the glass substrate and the silicon plate has been filled with the binder. The substrate with etched microchannels is kept coincidently with the cover and hold them tightly, and final curing of the binder is carried out by an ultraviolet irradiation via a mask. It is particularly noted to prevent the binder from entering microchannels during the bonding process, and the binder must be transferred from silicon plate to the substrate with etched microchannels quickly to avoid the volatilization of the binder. In comparison with other low temperature bonding methods using binders, this method has an advantage that the surface properties of the formed microchannels are essentially the same. Low temperature bonding technique can prevent binder from diffusing into microchannels thereby changing the properties of the channels or blocking the channels, thus meeting the demands of various studies, so that the chips' functions are more perfect and comprehensive. However, there are shortages that the usage of binder make the surface properties of microchannels inconsistent, and the binder may reacted with analyte which may disturb the analysis and pollute the analytical system, or the ambience is highly demanded, thereby being not suitable for mass-production of chips.

### DISCLOSURE OF INVENTION

An object of the present invention is to overcome the abovementioned defects of the prior bonding techniques, and to provide a novel method for bonding two solid planes having silicon, oxygen or metal and other elements at a molecular level, namely, a method for bonding two solid planes via surface assembling of active functional groups, thereby the bonding problems of the same planar solid materials or different planar solid materials in the preparation of semiconductor electronic devices, photo-sensitive devices and micro-electromechanical devices or biochips can be resolved. The planar solid materials used in these fields are mainly single crystal silicon wafers or chemical modified and various elements-doped single crystal silicon, single crystal silicon wafers with a flat surface and various diameters and various thicknesses, silicon oxide wafer or chemical modified and various elements-doped silicon oxide wafer, quartz plate or glass plate and other surfaces having silicon, oxygen or metal ions and the like. The object of the present invention is achieved by the following technical solution.

Here, the AA type, BB type, and AB type bonding referred by the invention are explained firstly.

(1) “AB type bonding” refers to a type of bonding wherein the active functional groups assembled in the surfaces of two substrates used in bonding are different, the terminal group carried by the film of one substrate is amino group, and the terminal group carried by the film of another substrate is any of anhydride group, aldehyde group, acyl halide group or isocyanate group, and the two substrates are contacted and press-bonded directly without any substance interposed therebetween, thereby a bonding is carried out. This type of bonding is most clean and practical, without any pollution and block in the micro-fluid channels networks; there are no low molecular residues; and the bonded substrate has a high strength and stability.

(2) “AA type bonding” refers to a type of bonding wherein the active functional groups assembled in the surfaces of two substrates used in bonding are amino, and the solid planes are bonding with a solution of a compound having bi-functional group or multi-functional group capable of reacting with the amino (e.g., dianhydride, diacyl halide, dialdehyde, or diisocyanate) interposed therebetween. With this type of bonding, the low molecular residues remained in the channels are not solidified, which may be cleaned away, but the amount of bi-functional compound in the solution used must be control strictly, namely, a relatively stronger bonding strength can be obtained only in the case where the amount thereof is equal to an amount required for an equal equivalent reaction with the amino groups on the solid plane, and the bonding strength will be decreased as a result of more or less reagents used.

(3) “BB type bonding” refers to a type of bonding wherein the active functional groups assembled in the surfaces of two substrates used in bonding are all groups that can react with amino, such as anhydride group, aldehyde group, acyl halide group, isocyanate group or the like, and the solid planes are bonding with a solution of a diamine or a polyamine interposed therebetween. With this type of bonding, the low molecular residues remained in the channels are not solidified, which may be cleaned away, but the amount of diamine or polyamine in the solution used must be control strictly, namely, a relatively stronger bonding strength can be obtained only in the case where the amount of amino groups is equal to an amount required for an equal equivalent reaction with the active functional groups on the solid plane, and the bonding strength will be decreased as a result of more or less diamine or polyamine used.

The mechanisms of the bonding reactions between two solid planes assembled with same or different active functional groups-containing films of the present invention are as follows:

(1) The Mechanism of AB Type Bonding of Mono-Layer Film:

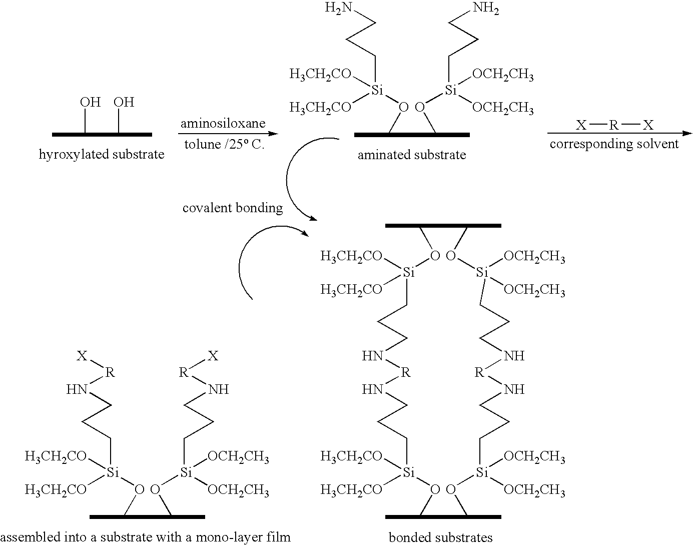

(2) The Mechanism of AB Type Bonding of Multi-Layers Film:

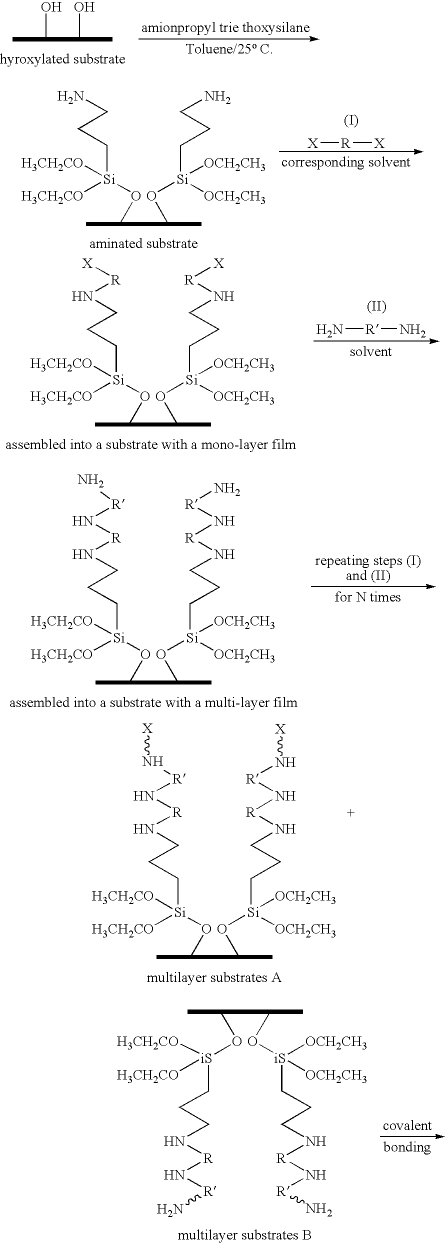

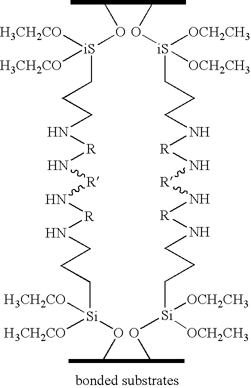

(3) The Mechanism of AA Type Bonding of Mono-Layer Film:

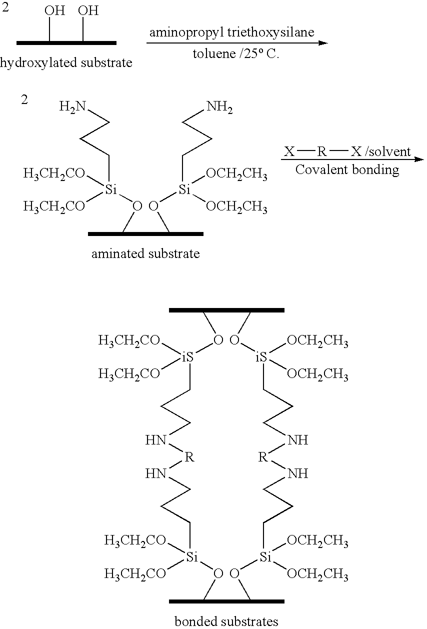

(4) The Mechanism of AA Type Bonding of Multi-Layers Film:

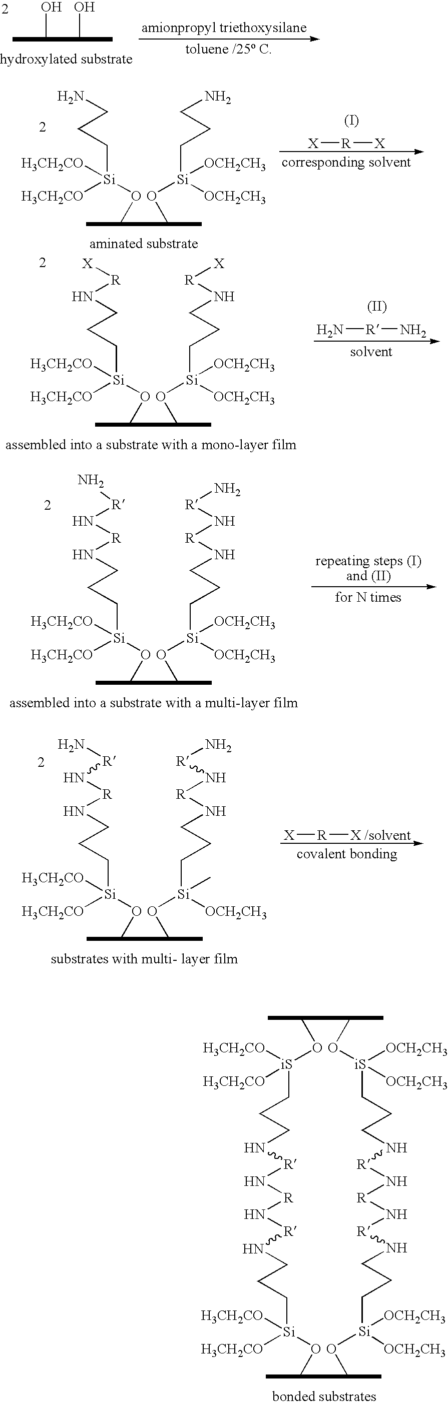

(5) The Mechanism of BB Type Bonding of Mono-Layer Film:

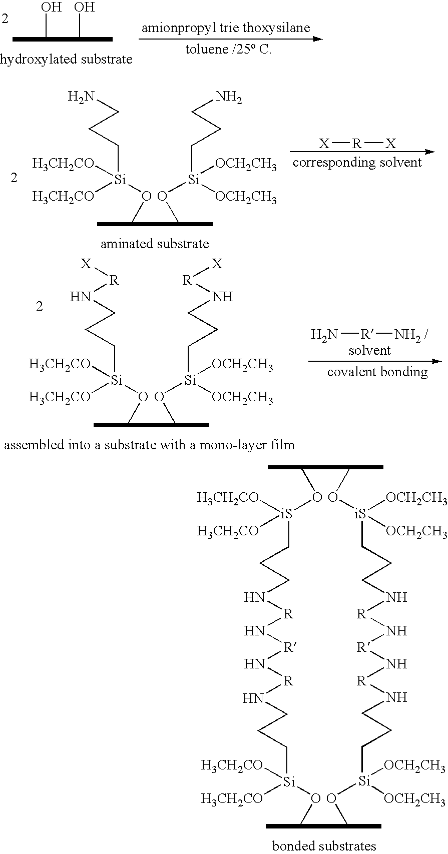

(6) The Mechanism of BB Type Bonding of Multi-Layers Film: 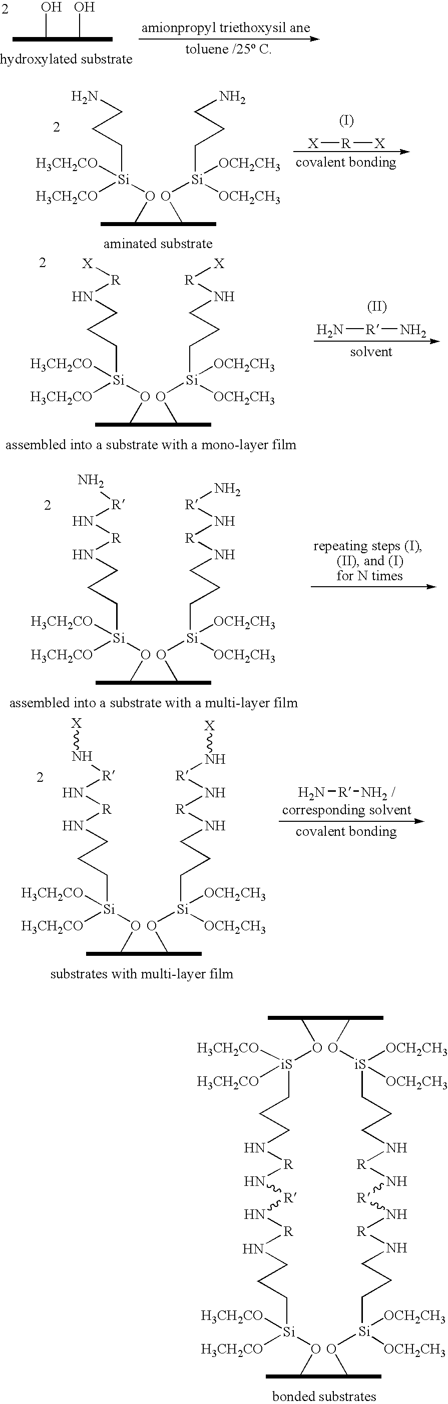
Wherein X—R—X and H₂N—R′—NH₂ are bi-functional or multi-functional compounds, R and R′ are molecular chains of aliphatic or aromatic compounds, X is mainly a functional group selected from anhydride group 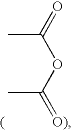
aldehyde group 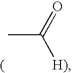
acyl halide group 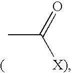
isocyanate group (—N═C═O) or the like which can react with amino group.

The present invention is as follows:

1. A method for bonding two solid planes via surface assembling of active functional groups, including the steps of:

(1) Cleaning the solid planes having silicon, oxygen or metal elements of substrates, and hydroxylating the solid planes to form hydroxyl groups thereon;

(2) Reacting the hydroxyl groups on the solid planes with an amino siloxane reagent to form amino groups on the solid planes;

(3) forming a mono-layer assembled film by the reaction of a compound monomer having an active bi-functional or multi-functional group with the amino groups on the solid planes; or forming bi-layer assembled film by the reaction of the mono-layer assembled film with a diamine or polyamine monomer, or forming multi-layer assembled film by repeating the above reactions,

(4) contacting two solid planes with assembled films having same or different active functional groups on their surfaces; and adding a solution containing another compound monomer having an active bi-functional or multi-functional group which can react with the functional group on the solid plane into the space between the two solid planes when the molecular films having the same active functional groups; and then reacting under the conditions of a temperature of 100-400° C. and a vacuum of less than 10 mmHg for 3-10 hours,

Wherein in the above-mentioned step (3),

The compound monomer having an active bi-functional or multi-functional group is any one selected from group consisting of compounds of I, II, III or IV types:
I. Anhydride-type compounds comprising mainly compounds each having two or more anhydride groups in a molecule;
II. Isocyanate-type compounds comprising mainly compounds each having two or more isocyanate groups in a molecule;
III. Acyl halide-type compounds comprising mainly compounds each having two or more acyl halide groups in a molecule; and
IV. aldehyde-type compounds comprising mainly compounds each having two or more aldehyde groups in a molecule;

The diamine or polyamine compounds comprise mainly compounds each having two or more amino groups in a molecule,
H₂N—R—NH₂
wherein R in the above-mentioned formula may be a molecular chain containing aromatic, aliphatic, cyclic or heterocyclic groups; and X is a halogen of F, Cl, Br or I;

The reaction of a compound monomer having an active bi-functional or multi-functional group with the amino groups on the solid planes is a solid-liquid reaction which is carried out in a solvent in the presence of a catalyst, wherein the solvent and catalyst are selected as follows:
With respect to the anhydride-type compounds, the solvent is selected mainly from N,N′-dimethylformamide, N,N′-dimethylacetamide, cresol, m-cresol, p-chlorophenol or N-methylpyrrolidone, and the catalyst is isoquinoline or triethylamine with a molar ratio of 0.5-1.0 to the monomer;
With respect to the isocyanate-type compounds, the solvent is selected mainly from N,N′-dimethylformamide or N,N′-dimethylacetamide;
With respect to the aldehyde-type compounds, the solvent is selected mainly from methanol, ethanol, tetrahydrofuran, N,N′-dimethylformamide or N,N′-dimethylacetamide, and the catalyst is acetic acid or formic acid with a volume ratio of 0.01-0.5% to the solvent; and

With respect to the diacyl chloride-type compounds, the solvent is selected mainly from dichloromethane, chloroform, toluene, benzene or carbon tetrachloride, and the catalyst is triethylamine, pyridine, N-methylpyridine or N,N′-dimethylpyridine with a volume ratio of 1-5% to the solvent.

2. A method for bonding two solid planes via surface assembling of active functional groups, including the steps of:

(1) Cleaning the solid planes having silicon, oxygen or metal elements of substrates, and hydroxylating the solid planes to form hydroxyl groups thereon; and

(2) Reacting the hydroxyl groups on the solid planes with an amino siloxane reagent to perform the surface amination;

Wherein the method further comprises the steps of:

(3) dissolving a compound monomer having an active bi-functional group or multi-functional group and a catalyst in a good solvent for the compound monomer wherein the ratio of said compound monomer to the good solvent is 0.1-10 mg/ml to obtain a solution, then applying the solution onto the aminated solid planes, and reacting at a temperature of 20-200° C. in a nitrogen gas atmosphere for 3-24 hours, thereby the amino group on the solid plane being reacted with an active functional group in the compound monomer to assemble into a monolayer molecular film, leaving other active functional group(s) on the film surface; or, placing the planar solid with the assembled monolayer molecular film on its surface into a solution containing a diamine or polyamine monomer, and assembling with the diamine or polyamine compound to form a bi-layer molecular film, wherein the remaining surface avtive functional group may be amino group; or repeating the assembling reactions between the planar solid having the assembled bi-layer molecular film on its surface and the active compounds so as to form a multi-layer molecular film on the solid plane; and

(4) keeping the two solid planes with the assembled monolayer molecular films, bi-layer molecular films or multi-layer molecular films having the same or different active functional groups on their surfaces contacting tightly, placing into a jig and pressing them tightly, or adding a solution containing another compound monomer having an active bi-functional or multi-functional group which can react with the functional group on the solid plane into the space between the two solid planes; then reacting under conditions of a temperature of 100-400° C. and a vacuum of less than 10 mmHg for 3-10 hours, then cooling them to room temperature at a cooling rate of 5-40° C. per hour, thereby forming covalent bonds between the two solid planes, thus achieving a stable bonding at molecular level;

Wherein in the above-mentioned step (3),

The compound monomer having an active bi-functional or multi-functional group is any one selected from the group consisting of the compounds of I, II, III or IV types:
I. Anhydride-type compounds comprising mainly compounds each having two or more anhydride groups in a molecule: 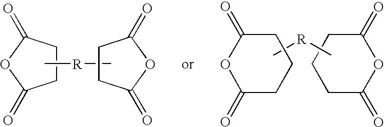
II. Isocyanate-type compounds comprising mainly compounds each having two or more isocyanate groups in a molecule:
   OCN—R—NCO
III. Acid halide-type compounds comprising mainly compounds each having two or more acyl halide groups in a molecule: 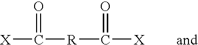
IV. Aldehyde-type compounds comprising mainly compounds each having two or more aldehyde groups in a molecule:
   OHC—R—CHO

The diamine or polyamine compounds comprise mainly compounds each having two or more amino groups in a molecule:
H₂N—R—NH₂

Wherein R in the above-mentioned formula may be a molecular chain containing aromatic, aliphatic, cyclic or heterocyclic groups; and X is halogen of F, Cl, Br, or I;

The reaction for assembling a molecular film on the solid plane is a solid-liquid reaction which is carried out in a good solvent for the bi-functional or multi-functional compound monomer, wherein the good solvent and catalyst selected are as follows:

With respect to the anhydride-type compounds, the solvent is selected mainly from N,N′-dimethylformamide, N,N′-dimethylacetamide, cresol, m-cresol, p-chlorophenol or N-methylpyrrolidone, and the catalyst is isoquinoline or triethylamine with a molar ratio of 0.5-1.0 to the monomer;
With respect to the isocyanate-type compounds, the solvent is selected mainly from N,N′-dimethylformamide or N,N′-dimethylacetamide;
With respect to the aldehyde-type compounds, the solvent is selected mainly from methanol, ethanol, tetrahydrofuran, N,N′-dimethylformamide or N,N′-dimethylacetamide, and the catalyst is acetic acid or formic acid with a volume ratio of 0.05-0.5% to the solvent;

With respect to the diacyl chloride-type compounds, the solvent is selected mainly from dichloromethane, chloroform, toluene, benzene or carbon tetrachloride, and the catalyst is triethylamine, pyridine, N-methylpyridine or N,N′-dimethylpyridine with a volume ratio of 1-5% related to the solvent.

3. The method for bonding two solid planes via surface assembling of active functional groups according to item 1 or 2, wherein a solid-solid reaction between the solid planes with assembled monolayer molecular films, bi-layer molecular films or multi-layer molecular films having different active functional groups on film surfaces is taking place in the step (4), resulting in the formation of covalent bonds between the two solid planes, thus achieving a stable AB type bonding at molecular level,

wherein the AB type bonding refers to a type of bonding wherein the active functional groups assembled in the surfaces of two substrates used in the bonding are different, the terminal group carried by the film of one substrate is amino group, and the terminal group carried by the film of another substrate is any of anhydride group, aldehyde group, acyl halide group or isocyanate group, and the two substrates are contacted and press-bonded directly without any substance interposed therebetween, thereby a bonding is carried out.

4. The method for bonding two solid planes via surface assembling of active functional groups according to item 1 or 2, wherein a solid-liquid reaction between the two solid planes having amino groups on film surfaces and a solution containing another active bi-functional or multi-functional compound monomer which can react with amino group interposed therebetween is taking place in the step (4), resulting in the formation of covalent bonds between the two solid planes, thus achieving a stable AA type bonding at molecular level,

wherein the AA type bonding refers to a type of bonding wherein the active functional groups assembled in the surfaces of two substrates used in the bonding are amino groups, and the solid planes are bonding with a solution interposed therebetween, wherein the solution contains a compound having bi-functional group or multi-functional group capable of reacting with amino group such as dianhydride, diacyl halide, dialdehyde or diisocyanate.

5. The method for bonding two solid planes via surface assembling of active functional groups according to item 1 or 2, wherein a solid-liquid reaction between the two solid planes having the same active functional groups capable of reacting with amino group amino groups on film surfaces and a solution containing a diamine or polyamine compound monomer interposed therebetween is taking place in the step (4), resulting in the formation of covalent bonds between the two solid planes, thus achieving a stable BB type bonding at molecular level,

wherein the BB type bonding refers to a type of bonding wherein the active functional groups assembled in the surfaces of two substrates used in bonding are all groups that can react with amino group comprising anhydride group, aldehyde group, acyl halide group or isocyanate group, and the solid planes are bonding with a solution of a diamine or a polyamine interposed therebetween.

6. The method for bonding two solid planes via surface assembling of active functional groups according to item 1 or 2, wherein the solid planes having silicon, oxygen or metal elements in step (1) comprise solid plane or wafer made of single crystal silicon, silicon oxide, metal elements-doped chemical modified silicon oxide, quartz or glass with a flat surface, and the surface roughness is in a range of 1 nm-20 nm.

7. The method for bonding two solid planes via surface assembling of active functional groups according to items 1 or 2, wherein the reaction temperatures are 50-200° C., 50-160° C., 40-100° C. and 20-100° C. in the case where the compound monomers having an active bi-functional or multi-functional groups in the step (3) are an anhydride-type compound, an isocyanate-type compound, an aldehyde-type compound and a diacyl chloride-type compound, respectively.

8. The method for bonding two solid planes via surface assembling of active functional groups according to item 1 or 2, wherein the temperature is 250-350° C. in the step (4).

9. The method for bonding two solid planes via surface assembling of active functional groups according to item 1 or 2, wherein covalent bonds are formed in the step (4) which comprise an amide linkage, 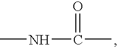
an urea linkage, 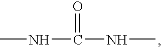
an imine linkage, 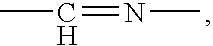
or an imide linkage,

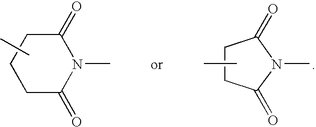

The beneficial effects of the present invention are significant. The method of the present invention is a novel method for bonding two solid planes having silicon, oxygen, metal or other elements at a molecular level. The solid planes are single crystal silicon wafers or various elements-doped single crystal silicon wafers subjected to a chemical modification; silicon oxide wafers or various elements-doped silicon oxide wafers subjected to a chemical modification; quartz plates or glass plates and other planes having silicon, oxygen, metal or other elements, which have flat surfaces and various diameters and various thicknesses, and apply for the preparations of semiconductor electronic devices, semiconductor photo-sensitive devices or biochips. The bonding reaction can be preformed between the same solid planar materials or different solid planar materials. The advantages of the method of the present invention are shown as follows:

The aminated substrate surfaces have an assembled molecular film carrying various active functional groups, such that a covalent bond can be formed between the substrate and a bi-functional compound, thereby a bonding of two solid planes at molecular level can be achieved;

the bonding reaction is carried out at a relatively low temperature compared with that of melt-bonding (600-1000° C.); no high voltage electric field is applied and no alkali metals pollution occur, this is different from a anode precipitation bonding (200-400° C., 1000-2000 V);

the present invention belongs to a solid-solid interface reaction, wherein the flatter and smoother the surfaces are, the more favorable for the contact-bonding of active functional groups between the planes, and the stronger bonding strength can be obtained;

the method of the present invention will neither block the micro-fluid inside channels nor pollute the micro-fluid inside networks, particularly, when the bonding reaction is carried out with a diisocyanate compound, and no low molecules (e.g., water or HCl molecule) is formed in the reaction, and no air bubbles and stress occur inside the substrate for bonding, and the bonding layer is clear and transparent, with a high shear strength after bonding; and

various active bi-functional or multi-functional molecule can be selected for assembling a film depending on the practical usage of chips or devices, wherein the active functional groups can remain in the micro-fluid channel besides their function of assemble-bonding of solid planes, for example, amino group can bond with enzymes, proteins, antigens and antibodies or biotin and other biochemical macromolecules or other biochemical reagents, for the separation, analysis and detection of various biochemical substances.

### BRIEF DESCRIPTION OF THE DRAWINGS

FIG. 1.1 is an UV spectrum of the assembled films formed by repeating alternately the reaction of terephthalic aldehyde and p-phenylenediamine on a quartz substrate surface; FIG. 1.2 is an UV spectrum of even layers of the assembled films of terephthalic aldehyde and p-phenylenediamine; and FIG. 1.3 is an UV spectrum of odd layers of the assembled films of p-phenylenediamine and terephthalic aldehyde.

FIG. 2.1 is an UV spectrum of the assembled films formed by repeating alternately the reaction of terephthalic aldehyde and 1,5-naphthalene diamine on a quartz substrate surface; FIG. 2.2 is an UV spectrum of even layers of the assembled films of terephthalic aldehyde and 1,5-naphthalene diamine; and FIG. 2.3 is an UV spectrum of odd layers of the assembled films of terephthalic aldehyde and 1,5-naphthalene diamine.

FIG. 3.1 is an UV spectrum of the assembled films formed by repeating alternately the reaction of pyromellitic dianhydride and p-phenylenediamine on a quartz substrate surface; FIG. 3.2 is an UV spectrum of even layers of the assembled films of pyromellitic dianhydride and p-phenylenediamine; and FIG. 3.3 is an UV spectrum of odd layers of the assembled films of pyromellitic dianhydride and p-phenylenediamine.

FIG. 4.1 is an UV spectrum of the assembled films formed by repeating alternately the reaction of pyrene dianhydride and p-phenylenediamine on a quartz substrate surface; FIG. 4.2 is an UV spectrum of even layers of the assembled films of pyrene dianhydride and p-phenylenediamine; and FIG. 4.3 is an UV spectrum of odd layers of the assembled films of pyrene dianhydride and p-phenylenediamine.

FIG. 5.1 is an UV spectrum of the assembled films formed by repeating alternately the reaction of ether dianhydride and p-phenylenediamine on a quartz substrate surface; FIG. 5.2 is an UV spectrum of even layers of the assembled films of ether dianhydride and p-phenylenediamine; and FIG. 5.3 is an UV spectrum of odd layers of the assembled films of ether dianhydride and p-phenylenediamine.

FIG. 6.1 is an UV spectrum of the assembled films formed by repeating alternately the reaction of pyrene dianhydride and ether diamine on a quartz substrate surface; FIG. 6.2 is an UV spectrum of even layers of the assembled films of pyrene dianhydride and ether diamine; and FIG. 6.3 is an UV spectrum of odd layers of the assembled films of pyrene dianhydride and ether diamine.

FIG. 7.1 is an UV spectrum showing a process of assembling and bonding a mono-layer film with ODPA on a quartz substrate surface; and FIG. 7.2 is an UV spectrum showing the neat UV spectra of ODPA before and after bonding which are obtained by subtracting the UV absorbances of aminated layer.

FIG. 8.1 is an UV spectrum showing a process of assembling and bonding a mono-layer film with 2,4-diisocyanate (TDI) on a quartz substrate surface; and FIG. 8.2 is an UV spectrum showing the neat UV spectra of TDI before and after bonding which are obtained by subtracting the UV absorbances of aminated layer.

FIG. 9.1 is an UV spectrum showing a process of assembling and bonding a mono-layer film with 4,4′-diisocyanate diphenylmethane (MDI) on a quartz substrate surface; and FIG. 9.2 is an UV spectrum showing the neat UV spectra of MDI before and after bonding which are obtained by subtracting the UV absorbances of aminated layer.

### DETAILED DESCRIPTION OF THE INVENTION

In the present invention, the assembling and bonding processes of the formation of multi-layer films on the surface of quartz substrates are followed and detected by ultraviolet-visible spectrograph (UV 2550, SHIMADZU), and the UV spectra and the explanations are as follows:

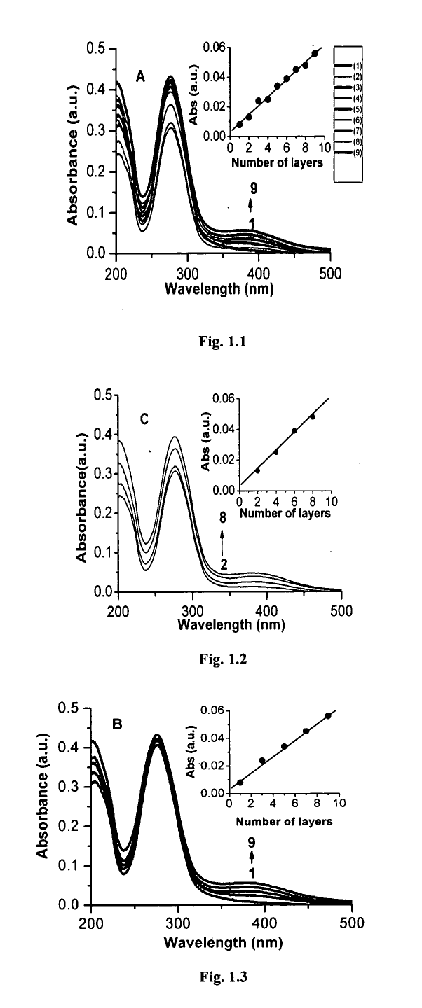

1. UV Detection Spectra of the Assembled Films Formed by Repeating Alternately the Reaction of Terephthalic Aldehyde and p-phenylenediamine on a Quartz Substrate Surface (FIGS. 1.1, 1.2, and 1.3)

A quartz substrate is treated according to the steps 1 to 3 of Example 4.3. During the treating process in the step 3, an UV absorbance spectral line is obtained after each layer of the assembled film being formed with terephthalic aldehyde or p-phenylenediamine. The resultant FIG. 1.1 can be divided into FIG. 1.2 and FIG. 1.3 in term of odd layers and even layers.

The mechanism of the assembling reaction is as follows:

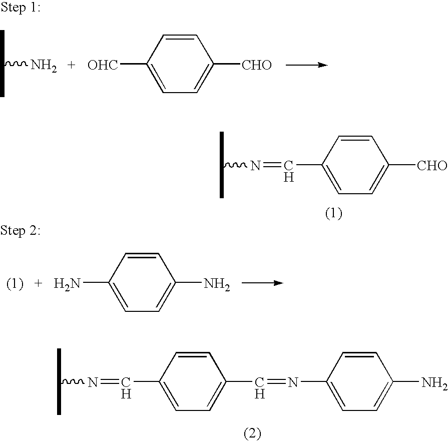

Multi-layer assembled films are obtained by repeating steps 1 and 2

The spectral lines 1, 3, 5, 7, and 9 in FIG. 1.1 are UV absorbance spectral lines when terephthalic aldehyde is used for the surface layer of assembled film, wherein the terminal functional group of the assembled film is an aldehyde group. The spectral lines 2, 4, 6, and 8 are UV absorbance spectral lines when p-phenylenediamine is used for the surface layer of assembled film, wherein the terminal functional group of the assembled film is an amino group. As can be seen from FIG. 1.1, the peak values at 319 nm increase with the increasing of number of layers of the assembled film. This peak characterizes the UV absorbance profile of Schiff base segment formed by terephthalic aldehyde and p-phenylenediamine. As the number of assembled layers increases, the Schiff base segment of formed oligomer becomes longer, thereby the UV absorbance thereof increases, too. However, the peak value at 276 nm changes alternately with the increasing of layer number, suggesting the alternative changes of the bi-functional compounds at the terminals of assembled films, because this peak characterizes mainly the UV absorbance profile of bi-functional compounds at the terminal group of the assembled film. In the view of the structures of compounds, aldehyde group is an electron-attracting group, and amino group is an electron-donating group. Generally, an electron-attracting group will increase the UV absorbance intensity of a benzene ring. In the case of an odd layer which is an assembled layer of terephthalic aldehyde, the outermost layer of the assembled film is made of terephthalic aldehyde whose molar extinction coefficient ε is larger than that of p-phenylenediamine, thus the odd layer has a stronger absorbance, and the peak value thereof is higher. In the case of an even layer which is an assembled layer of p-phenylenediamine, the outermost layer of the assembled film is made of p-phenylenediamine whose molar extinction coefficient ε is smaller than that of terephthalic aldehyde, thus the even layer has a weaker absorbance, and the peak value thereof is lower. Therefore, as can be seen from the spectrum, the peak values of odd layers are higher than that of even layers. If the spectral lines in the spectrum are divided in term of odd layers and even layers, this regularity will be apparent. As to FIG. 1.2 which is an UV spectrum of even layers of the assembled films of terephthalic aldehyde and p-phenylenediamine, the UV absorbance intensities increase with the number of layers with respect to even layers. As to FIG. 1.3 which is an UV spectrum of odd layers of the assembled films of terephthalic aldehyde and p-phenylenediamine, the UV absorbance intensities also increase with the number of layers with respect to odd layers.

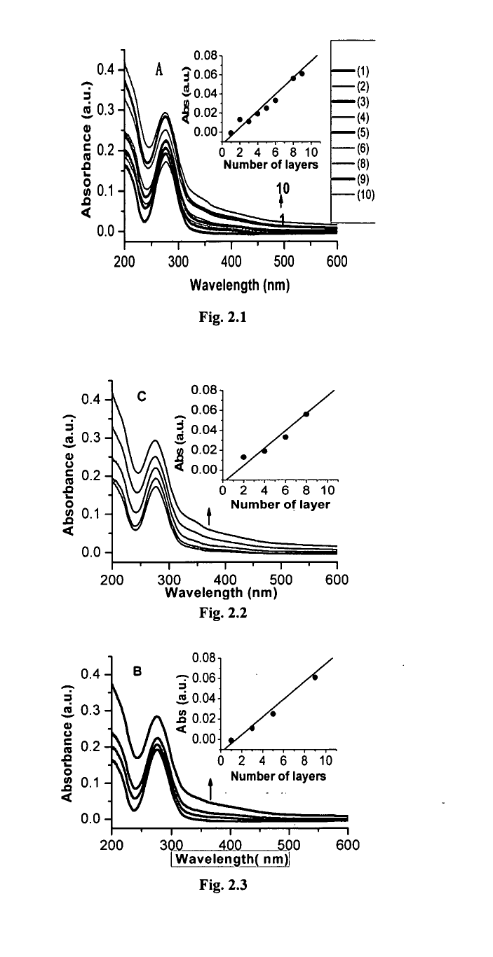

The same regularity can be seen in the assembled film of terephthalic aldehyde and 1,5-naphthalene diamine on a quartz substrate, which is shown in FIG. 2.1, FIG. 2.2, and FIG. 2.3.

2. UV Detection Spectra of the Assembled Films Formed by Repeating Alternately the Reaction of Terephthalic Aldehyde and 1,5-naphthalene Diamine on a Quartz Substrate Surface (FIG. 2.1, FIG. 2.2, and FIG. 2.3)

A quartz substrate is treated according to the steps 1 to 3 of Example 4.3. During the treating process in the step 3, an UV absorbance spectral line is detected after each layer of the assembled film being formed with terephthalic aldehyde or 1,5-naphthalene diamine. The resultant spectrum FIG. 2.1 can be divided into FIG. 2.2 and FIG. 2.3 in term of odd layers and even layers.

The mechanism of the reaction for assembled film is as follows:

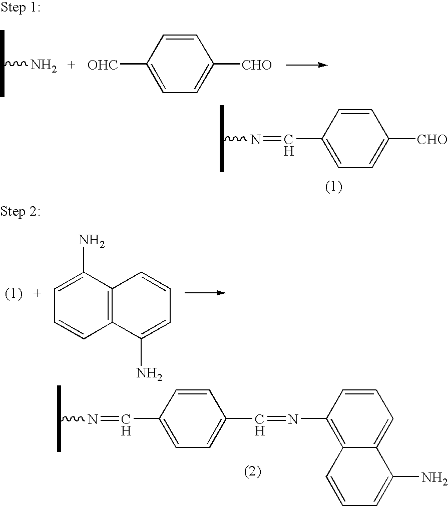

Multi-layer assembled films are obtained by repeating steps 1 and 2

The spectral lines 1, 3, 5, and 9 in FIG. 2.1 are UV absorbance spectral lines when terephthalic aldehyde is used for the surface layer of assembled film, wherein the terminal functional group thereof is an aldehyde group. The spectral lines 2, 4, 6, 8, and 10 are UV absorbance spectral lines when 1,5-naphthalene diamine is used for the surface layer of assembled film, wherein the terminal functional group thereof is an amino group. As can be seen from FIG. 2.1, the absorbance values at about 340 nm increase with the increasing of number of layers of the assembled film. This peak characterizes the UV absorbance profile of Schiff base segment formed by terephthalic aldehyde and 1,5-naphthalene diamine. As the number of assembled layers increases, the Schiff base segment of formed oligomer becomes longer, thereby the UV absorbance thereof increases, too. However, the peak value at 275 nm changes alternately with the increasement of layer number, suggesting the alternative changes of the bi-functional compounds at the terminals of assembled films, because this peak characterizes mainly the UV absorbance profile of bi-functional compounds at the terminal group of the assembled film. In the view of the structures of compounds, aldehyde group is an electron-attracting group, and amino group is an electron-donating group. Generally, an electron-attracting group will increase the UV absorbance intensity of a benzene ring. In the case of an odd layer which is an assembled layer of terephthalic aldehyde, the outermost layer of the assembled film is made of terephthalic aldehyde whose molar extinction coefficient ε is larger than that of 1,5-naphthalene diamine, thus the odd layer has a stronger absorbance, and the peak value thereof is higher. In the case of an even layer which is an assembled layer of 1,5-naphthalene diamine, the outermost layer of the assembled film is made of 1,5-naphthalene diamine whose molar extinction coefficient ε is smaller than that of terephthalic aldehyde, thus the even layer has a weaker absorbance, and the peak value thereof is lower. Therefore, as can be seen from the spectrum, the peak value of odd inner layer is higher than that of the adjacent outer layer. If the spectral lines in the spectrum are divided in term of odd layers and even layers, the following regularity will be apparent. As to FIG. 2.2 which is an UV spectrum of even layers of the assembled films of 1,5-naphthalene diamine and terephthalic aldehyde, the UV absorbance intensities increase gradually with the number of layers with respect to even layers. As to FIG. 2.3 which is an UV spectrum of odd layers of the assembled films of 1,5-naphthalene diamine and terephthalic aldehyde, the UV absorbance intensities also increase gradually with the number of layers with respect to odd layers. The resultant regularity is similar with the regularity of UV absorbance spectrum FIG. 1.1 of assembled films formed by p-phenylenediamine and terephthalic aldehyde, but is not completely the same. Because the difference in molar extinction coefficient ε between 1,5-naphthalene diamine and terephthalic aldehyde is very small, the UV absorbance intensities at 275 nm of odd layers and even layers are interlaced. While the difference in molar extinction coefficient ε between p-phenylenediamine and terephthalic aldehyde is relative large, therefore the UV absorbance intensities of odd layers at 275 nm are all higher than those of even layers.

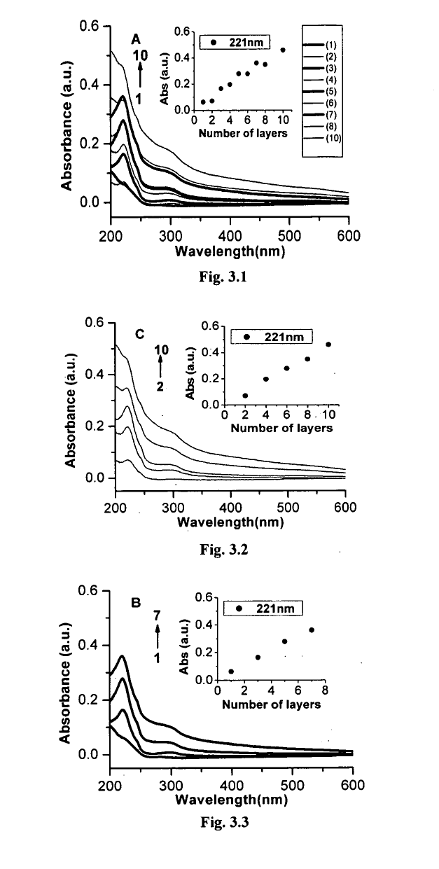

3. UV Spectra of the Assembled Films Formed by Repeating Alternately the Reaction of Pyromellitic Dianhydride and p-phenylenediamine on a Quartz Substrate Surface (FIG. 3.1, FIG. 3.2 and FIG. 3.3)

A quartz substrate is treated according to the steps 1 to 3 of Example 1.3. During the treating process in the step 3, an UV absorbance spectral line is detected after each layer of the assembled film being formed with pyromellitic dianhydride or p-phenylenediamine. The resultant FIG. 3.1 can be divided into FIG. 3.2 and FIG. 3.3 in term of odd layers and even layers.

The mechanism of the assembling reaction is as follows:

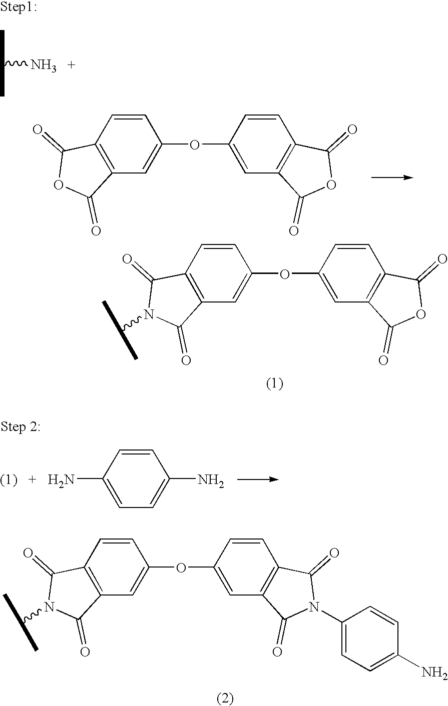

Repeat Step 1 and Step 2 to obtain multilayer wafer

The spectral lines 1, 3, 5, and 7 in FIG. 3.1 are UV absorbance spectral lines when pyromellitic dianhydride is used for the surface layer of assembled film, wherein the terminal functional group thereof is an anhydride group. The spectral lines 2, 4, 6, 8, and 10 are UV absorbance spectral lines when p-phenylenediamine is used for the surface layer of assembled film, wherein the terminal functional group thereof is an amino group. As can be seen from FIG. 3.1, the UV absorbance values at 379 nm increase with the increasing of number of layers of the assembled film. This peak characterizes the UV absorbance profile of imide segment formed by pyromellitic dianhydride and p-phenylenediamine. As the number of assembled layers increases, the imide segment of formed oligomer increases gradually, thereby the UV absorbance thereof increases, too. The peak values at 222 nm increase also with the increasement of layer number, suggesting the increasement of bi-functional compounds in assembled films, because this peak characterizes mainly the UV absorbance profile of bi-functional compounds at the terminal group of the assembled film. In the view of the structures of compounds, anhydride group is an electron-attracting group, and amino group is an electron-donating group. Generally, an electron-attracting group will increase the UV absorbance intensity of a benzene ring, while an electron-donating group will decrease the UV absorbance intensity of a benzene ring. Since effects of an anhydride group and an amino group on the molar extinction coefficient ε of a benzene ring are similar, the molar extinction coefficient ε of pyromellitic dianhydride is similar to that of p-phenylenediamine. Therefore, as can be seen from FIG. 3.1, the UV absorbance intensity of an odd inner layer is close to that of the adjacent outer layer. If the spectral lines in the spectrum are divided in term of odd layers and even layers, the regularity that the UV absorbance intensities of assembled films increase with the increasement of layer number will be more apparent. As to FIG. 3.2 which is an UV spectrum of even layers of the assembled films of pyromellitic dianhydride and p-phenylenediamine, the UV absorbance intensities increase gradually with the increasement of layer number with respect to even layers. As to FIG. 3.3 which is an UV spectrum of odd layers of the assembled films of pyromellitic dianhydride and p-phenylenediamine, the UV absorbance intensities also increase gradually with the increasement of layer number with respect to odd layers.

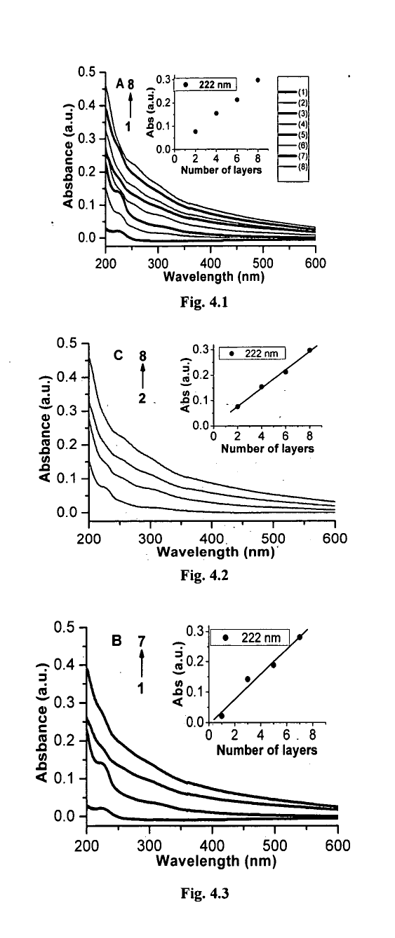

4. UV Detection Spectra of the Assembled Films Formed by Repeating Alternately the Reaction of Pyrene Dianhydride and p-phenylenediamine on a Quartz Substrate Surface (FIGS. 4.1, 4.2, and 4.3)

A quartz substrate is treated according to the steps 1 to 3 of Example 1.3. During the treating process in the step 3, an UV absorbance spectral line is detected after each layer of the assembled film being formed with pyrene dianhydride or p-phenylenediamine. The resultant FIG. 4.1 can be divided into FIG. 4.2 and FIG. 4.3 in term of odd layers and even layers.

The mechanism of the assembling reaction is as follows:

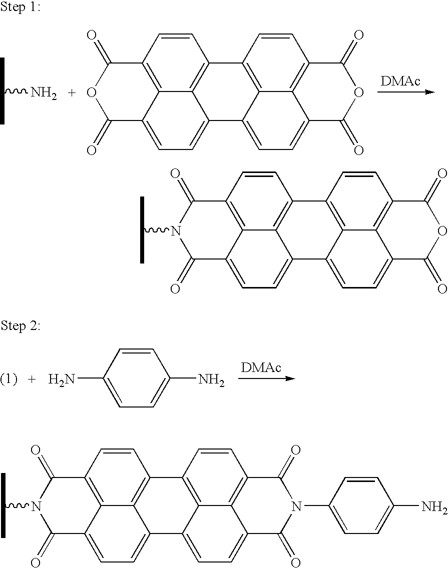

Multi-layer assembled films are obtained by repeating steps 1 and 2

The spectral lines 1, 3, 5, and 7 in FIG. 4.1 are UV absorbance spectral lines when pyrene dianhydride is used for the surface layer of assembled film, wherein the terminal functional group thereof is an anhydride group. The spectral lines 2, 4, 6, and 8 are UV absorbance spectral lines when p-phenylenediamine is used for the surface layer of assembled film, wherein the terminal functional group thereof is an amino group. As can be seen from FIG. 4.1, there are no evident characteristic peak as the layer number of the assembled films increases. However, UV absorbance intensity of the whole spectral line increases gradually as the layer number of the assembled films increases. The reason is that the imide segments of formed oligomers become longer gradually, thus the UV absorbance intensities increase with them, too. If the spectral lines in the spectrum are divided in term of odd layers and even layers, the regularity that the UV absorbance intensities of assembled films increase with the increasement of layer number will be more apparent. As to FIG. 4.2 which is an UV spectrum of even layers of the assembled films of pyrene dianhydride and p-phenylenediamine, the UV absorbance intensities increase gradually with the increasement of layer number with respect to even layers. As to FIG. 4.3 which is an UV spectrum of odd layers of the assembled films of pyrene dianhydride and p-phenylenediamine, the UV absorbance intensities also increase gradually with the increasement of layer number with respect to odd layers.

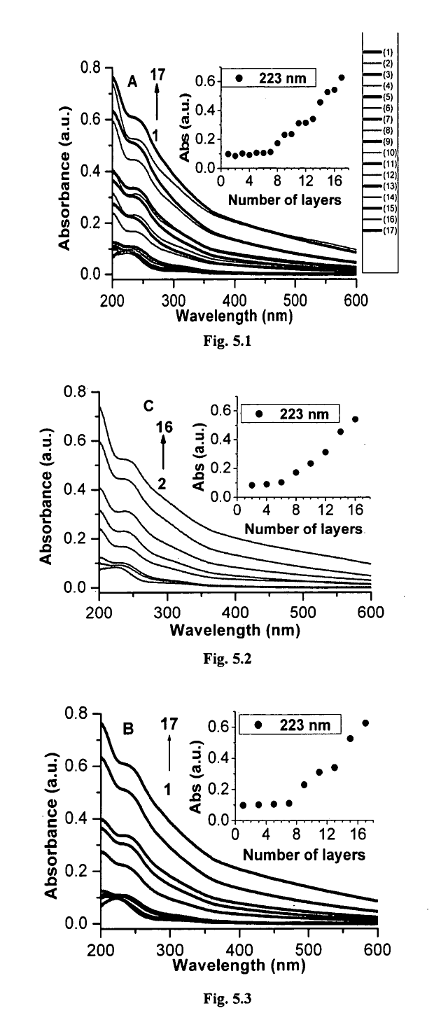

5. UV Detection Spectra of the Assembled Films Formed by Repeating Alternately the Reaction of Ether Dianhydride and p-phenylenediamine on a Quartz Substrate Surface (FIGS. 5.1, 5.2, and 5.3)

A quartz substrate is treated according to the steps 1 to 3 of Example 1.3. During the treating process in the step 3, an UV absorbance spectral line is detected after each layer of the assembled film being formed with p-phenylenediamine or ether dianhydride. The resultant FIG. 5.1 can be divided into FIG. 5.2 and FIG. 5.3 in term of odd layers and even layers.

The mechanism of the assembling reaction is as follows:

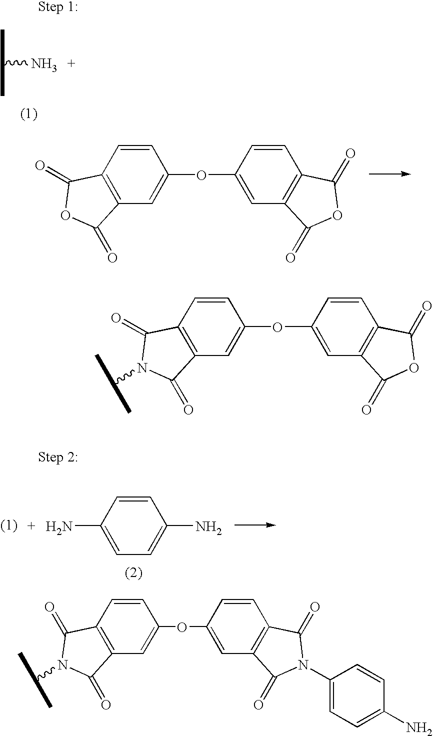

Multi-layer assembled films are obtained by repeating steps 1 and 2

The spectral lines 1, 3, 5, 7, 9, 11, 13, 15, and 17 in FIG. 5.1 are UV absorbance spectral lines when ether dianhydride is used for the surface layer of assembled film, wherein the terminal functional group thereof is an anhydride group; spectral lines 2, 4, 6, 8, 10, 12, 14, and 16 are UV absorbance spectral lines when p-phenylenediamine is used for the surface layer of assembled film, wherein the terminal functional group thereof is an amino group. As can be seen from FIG. 5.1, there are no characteristic peak as the layer number of the assembled films increases. However, there is an evident characteristic inflexion point at 223 nm, and the UV absorbance intensity thereof increases gradually as the layer number of the assembled films increases. The reason is that the imide segments of formed oligomers become longer gradually, thus the UV absorbance intensities increase with them, too. The shapes of the spectral lines change corresponding to the alternative changes of the terminal functional groups. If the spectral lines in the spectrum are divided in term of odd layers and even layers, the regularity that the UV absorbance intensities of assembled films increase with the increasement of layer number and the shapes of the spectral lines change corresponding to the alternative changes of the terminal functional groups will be more apparent. As to FIG. 5.2 which is an UV spectrum of even layers of the assembled films of ether dianhydride and p-phenylenediamine, with respect to even layers, the UV absorbance intensities increase gradually with the increasement of layer number, and the shapes of individual spectral lines are similar. As to FIG. 5.3 which is an UV spectrum of odd layers of the assembled films of ether dianhydride and p-phenylenediamine, the UV absorbance intensities also increase gradually with the increasement of layer number with respect to odd layers, and the shapes of individual spectral lines are similar. However, the shapes of odd layers and even layers are different, reflecting a regular change of terminal functional groups of the assembled films.

6. UV Detection Spectra of the Assembled Films Formed by Repeating Alternately the Reaction of Pyrene Dianhydride and Ether Diamine on a Quartz Substrate Surface (FIGS. 5.1, 5.2, and 5.3)

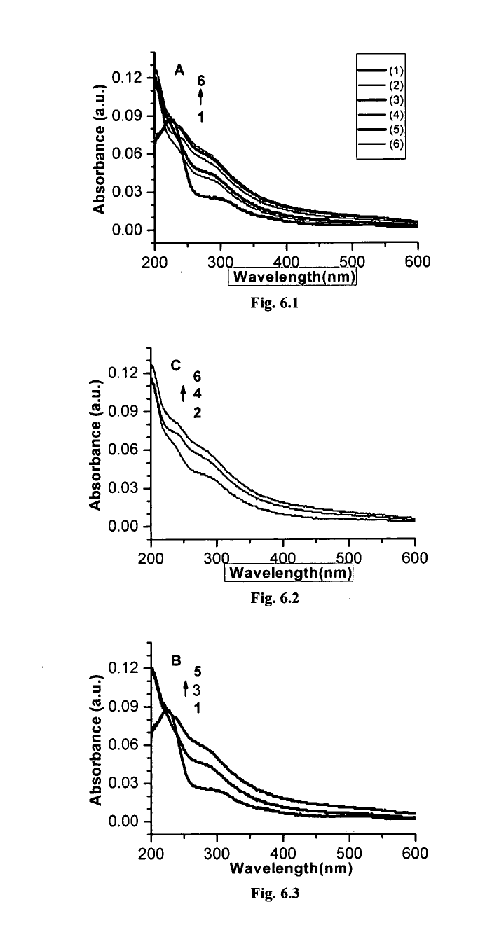

A quartz substrate is treated according to the steps 1 to 3 of Example 1.3 except for the aminating reagent used in step 2 is aminopropyl methoxy dimethyl silane. The assembled mono-layer aminated film has a related low amino group density of 0.8 amino groups/nm². During the treating process in the step 3, an UV absorbance spectral line is detected after each layer of the assembled film being formed with pyrene dianhydride or ether diamine. The resultant FIG. 6.1 can be divided into FIG. 6.2 and FIG. 6.3 in term of odd layers and even layers.

The mechanism of the assembling reaction is as follows:

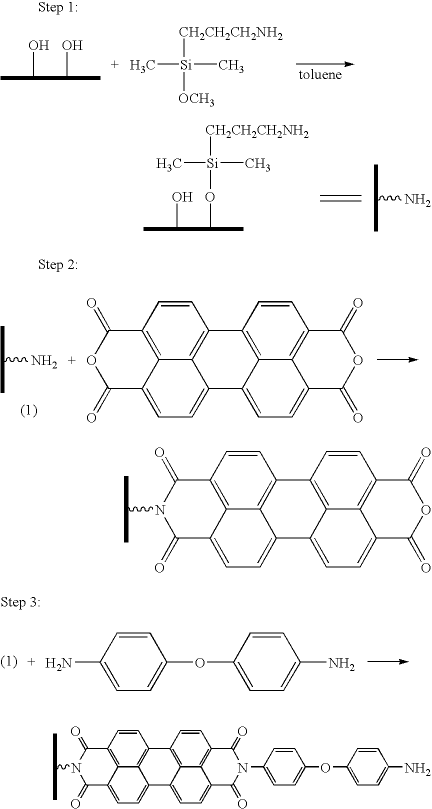

Multi-layer assembled films are obtained by repeating steps 2 and 3.

The spectral lines 1, 3, and 5 in FIG. 6.1 are UV absorbance spectral lines when pyrene dianhydride is used for the surface layer of assembled film, wherein the terminal functional group thereof is an anhydride group. The spectral lines 2, 4, and 6 are UV absorbance spectral lines when ether diamine is used for the surface layer of assembled film, wherein the terminal functional group thereof is an amino group. As can be seen from FIG. 6.1, there are no evident characteristic peak as the layer number of the assembled films increases. However, UV absorbance intensity of the whole spectral line increases gradually as the layer number of the assembled films increases. The reason is that the imide segments of formed oligomers become longer gradually, thus the UV absorbance intensities increase with them, too. If the spectral lines in the spectrum are divided in term of odd layers and even layers, the regularity that the UV absorbance intensities of assembled films increase with the increasement of layer number will be more apparent. As to FIG. 6.2 which is an UV spectrum of even layers of the assembled films of pyrene dianhydride and ether diamine, the UV absorbance intensities increase gradually with the increasement of layer number with respect to even layers. As to FIG. 6.3 which is an UV spectrum of odd layers of the assembled films of pyrene dianhydride and ether diamine, the UV absorbance intensities also increase gradually with the increasement of layer number with respect to odd layers.

7. The Bonding Process of Quartz Substrates with ODPA as a Molecule for Mono-Layer Assembled Film Followed and Detected by UV-Visible Absorbance Spectra

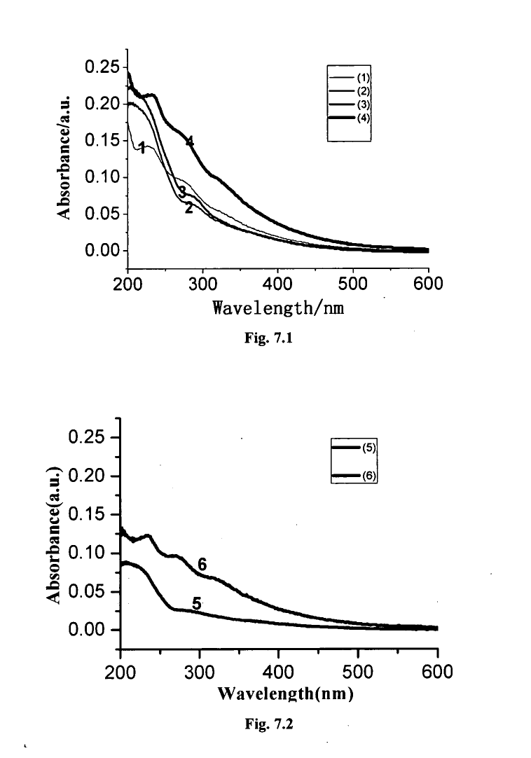

Quartz substrates are treated according to the steps 1 to 4 of Example 1.3. However, an UV absorbance spectral line is measured before and after each step, thus FIG. 7.1 and FIG. 7.2 are obtained.

The mechanism of the assembling reaction is as follows:

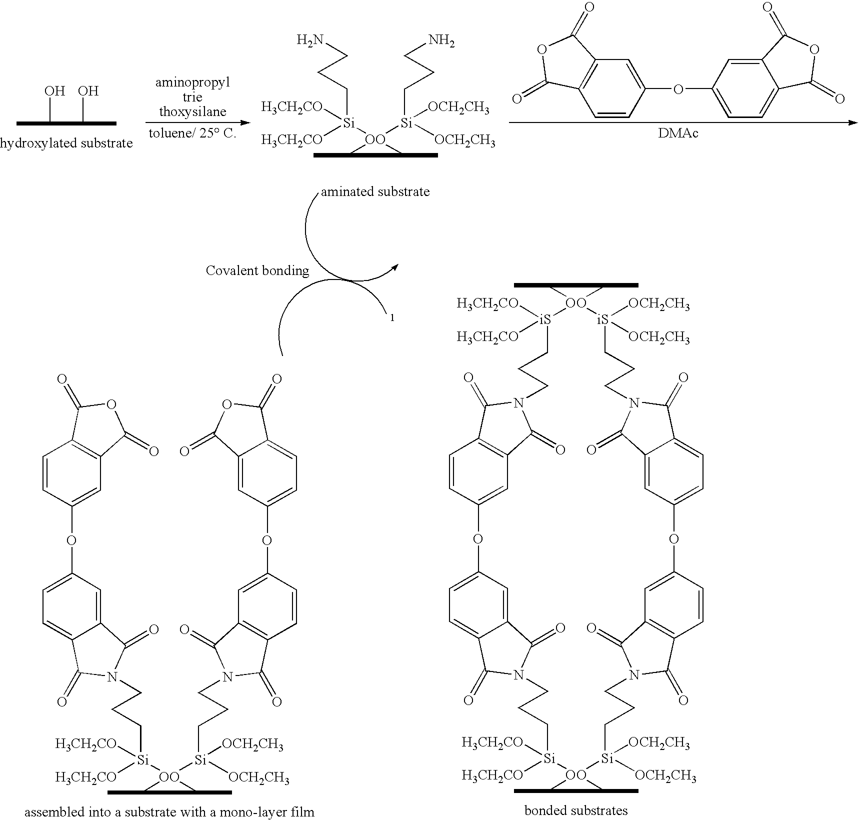

Mono-layer assembled films are obtained on quartz substrates using 3,3′,4,4′-diphenyl ether dianhydride (ODPA) as a monomer of bi-functional compound, and the UV spectral changes of the two substrates before and after bonding are detected to follow and monitor the structural changes before and after bonding. The obtained results are shown in FIG. 7.1 and FIG. 7.2.

In FIG. 7.1, spectral line (1) is an UV absorbance spectrum of an aminated substrate for bonding. Spectral line (2) is an UV absorbance spectrum of an assembled mono-layer film formed by the reaction between the aminated substrate and 3,3′,4,4′-diphenyl ether dianhydride (ODPA). Spectral line (3) is an UV absorbance spectrum after keeping the substrate with the mono-layer film of ether dianhydride formed thereon contacting tightly with another aminated substrate and before bonding. Spectral line (4) is an UV absorbance spectrum after bonding the two substrates. Compared spectral line (4) with spectral line (3), it can be seen that a characteristic peak at 232 nm appears after bonding, suggesting that a significant change of the structure of the assembled film takes place after bonding, namely, a covalent bond has been formed. The spectrum is further treated by subtracting the UV absorbance of the aminated layer from spectral line (3) and spectral line (4), thereby spectral line (5) and spectral line (6) in FIG. 7.2 which show the UV absorbance changes of ether dianhydride before and after bonding are obtained, respectively. From FIG. 7.2, it can reveal more remarkably the structural changes of ether dianhydride before and after bonding, suggesting that a covalent bonding reaction is taking place and an imide linkage is formed.

8. The Bonding Process of Quartz Substrates with 2,4-Diisocyanate (TDI) as a Molecule for Mono-Layer Assembled Film Followed and Detected by UV-Visible Absorbance Spectra

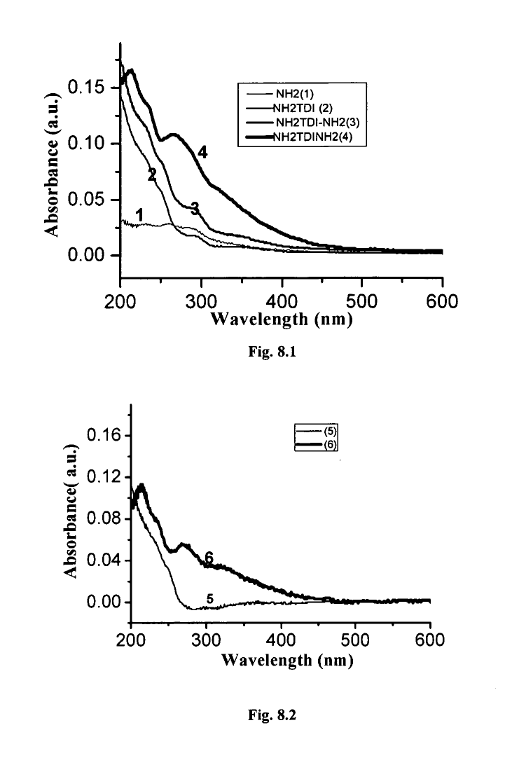

Quartz substrates are treated according to the steps 1 to 4 of Example 2.3. However, an UV absorbance spectral line is measured before and after each step, thus FIG. 8.1 and FIG. 8.2 are obtained. The mechanism of the assembling reaction is as follows:

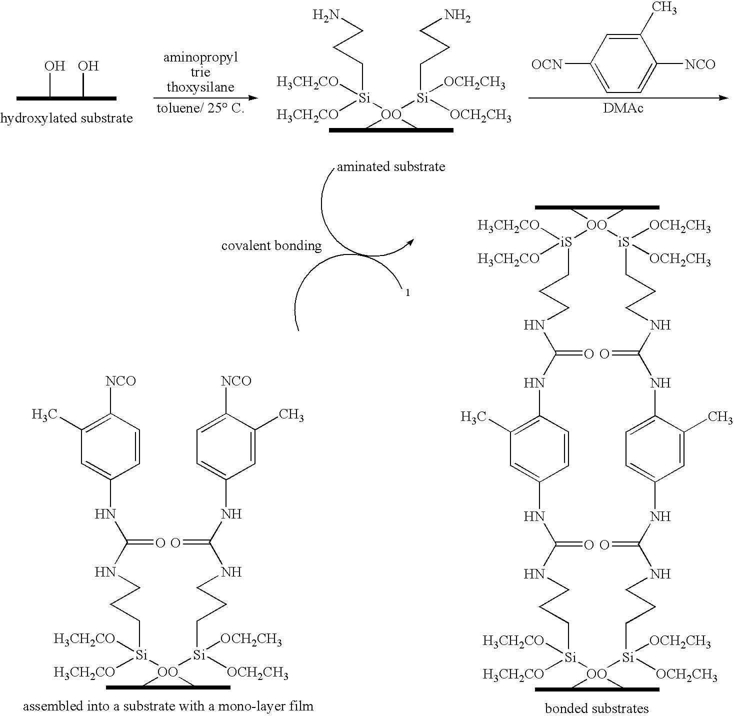

Mono-layer assembled films are obtained on quartz substrates using 2,4-diisocyanate (TDI) as a monomer of bi-functional compound, and the UV spectral changes of the two substrates before and after bonding are detected to follow and monitor the structural changes before and after bonding. The obtained results are shown in FIG. 8.1 and FIG. 8.2.

In FIG. 8.1, spectral line (1) is an UV absorbance spectrum of an aminated substrate for bonding. Spectral line (2) is an UV absorbance spectrum of an assembled mono-layer film formed by the reaction between the aminated substrate and 2,4-diisocyanate. Spectral line (3) is an UV absorbance spectrum after keeping the substrate with the mono-layer film of 2,4-diisocyanate (TDI) formed thereon contacting tightly with another aminated substrate and before bonding. Spectral line (4) is an UV absorbance spectrum after bonding the two substrates. As compared spectral line (4) with spectral line (3), it can be seen that characteristic peaks at 210 nm and 265 nm appear after bonding, suggesting that a significant change of the structure of the assembled film takes place after bonding, namely, a covalent bond has been formed. If the spectrum is further treated by subtracting the UV absorbance of the aminated layer from spectral line (3) and spectral line (4), spectral line (5) and spectral line (6) in FIG. 8.2 which show only the UV absorbance changes of 2,4-diisocyanate in the assembled film before and after bonding are obtained, respectively. From FIG. 8.2, it can reveal more remarkably the structural changes of 2,4-diisocyanate before and after bonding, suggesting that a covalent bonding reaction is taking place and a urea linkage is formed.

9. The Bonding Process of Quartz Substrates with 4,4′-diisocyanate Diphenyl Methane (MDI) as a Molecule for Mono-Layer Assembled Film Followed and Detected by UV-Visible Absorbance Spectra

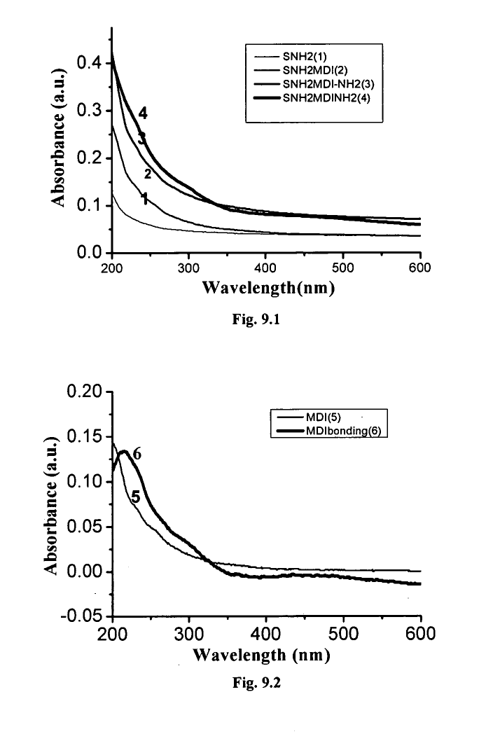

Quartz substrates are treated according to the steps 1 to 4 of Example 2.3. However, an UV absorbance spectral line is measured before and after each step, thus FIG. 9.1 and FIG. 9.2 are obtained. The mechanism of the assembling reaction is as follows:

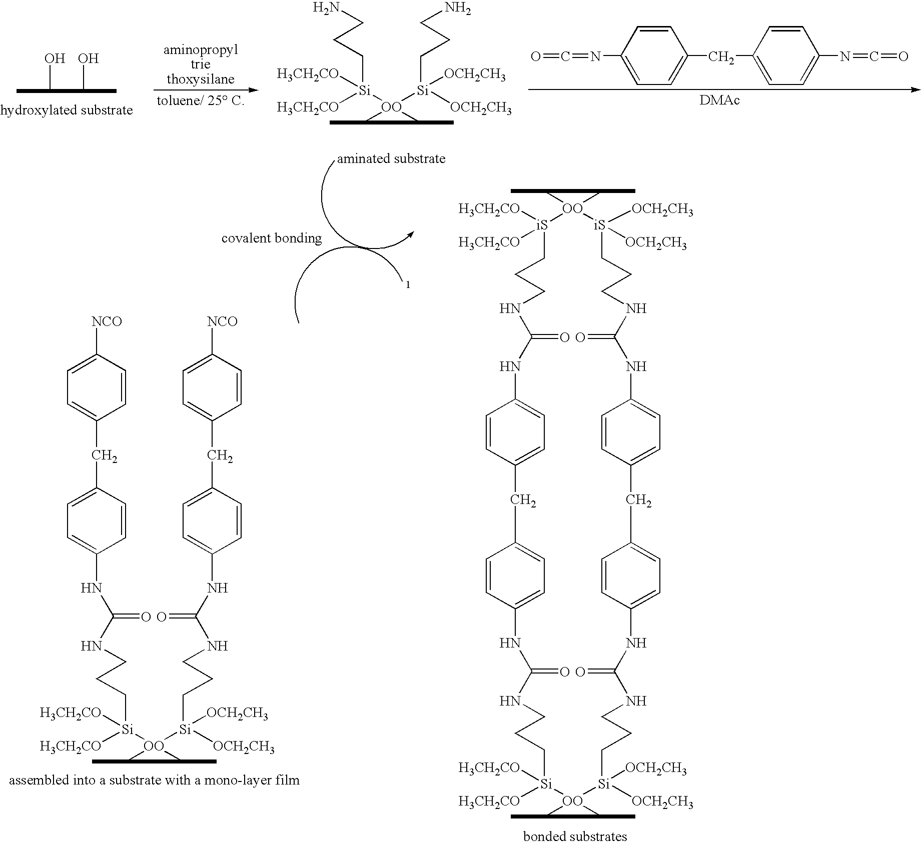

In FIG. 9.1, spectral line (1) is an UV absorbance spectrum of an aminated substrate for bonding. Spectral line (2) is an UV absorbance spectrum of an assembled mono-layer film formed by the reaction between the aminated substrate and MDI. Spectral line (3) is an UV absorbance spectrum after keeping the substrate with the mono-layer MDI film formed thereon contacting tightly with another aminated substrate and before bonding. Spectral line (4) is an UV absorbance spectrum after bonding the two substrates. As compared spectral line (4) with spectral line (3), it can be seen that no evident characteristic peak appears after bonding. However, the shapes of the spectral lines are changed significantly, suggesting that a structural change of the assembled film takes place after bonding, and a covalent bond has been formed. If the spectrum is further treated by subtracting the UV absorbance of the aminated layer from spectral line (3) and spectral line (4), spectral line (5) and spectral line (6) in FIG. 9.2 which show only the UV absorbance changes of MDI before and after bonding are obtained, respectively. From FIG. 9.2, it can be seen more apparently that an evident characteristic peak appears at 216 nm in the spectral line (6) after bonding, suggesting that a covalent bonding reaction is taking place and a urea linkage is formed.

### EXAMPLES

The present invention will be described in detail with reference to series of examples which are divided on the types of bi-functional compounds for assembling films (dianhydride, diisocyanate, diacyl chloride and dialdehyde) and the types of bonding (AB, AA and BB). The shear strengths of bonded substrates are measured using an INSTRON-1121 type material tester.

### Example 1

Methods of Bonding Two Solid Planes with Imide Linkages Formed by Reacting Dianhydride-Type Bi-Functional Compounds with Amino Groups

The materials for bonding in these examples were silicon plate, quartz plate or glass plate. The bonding reactions could be performed between two solid planes made of the same materials or different materials, and the shear strengths of the bonded solid planes were similar.

### Example 1.1

### AB-Type Bonding of a Substrate with an Assembled Mono-Layer Film Formed by Dianhydride Compounds and an Aminated Substrate

The bonding process of two solid planes in this example comprised four steps: step 1 was a step of cleaning and hydroxylating of substrates; step 2 was a step of aminating the hydroxylated substrates; step 3 was a step of forming a mono-layer assembled film with a dianhydride-type bi-functional monomer on the surface of the aminated substrate; and step 4 was a step of bonding the substrate having an anhydride group on its surface with the substrate having an amino group on its surface. The detail descriptions were as follows:

Step 1: Cleaning and Hydroxylating of Substrates

Substrates of glass, quartz or silicon plate with a surface being oxidized into silicon oxide advanced were cleaned firstly with deionized water for 5 minutes in an ultrasonic instrument, then ultrasonically cleaned with a solution of ethanol (95%) at 30° C. for 5 minutes, with dichloromethane for 5 minutes, and a solution of mixture of NH₃ (25%): H₂O₂ (30%): H₂O=1:1:5 (V/V/V) at 70° C. for 30 minutes. Thereafter, the substrates were washed with enough water to be neutral, then ultrasonically cleaned with a solution of hydrochloric acid (37%): water=1:6 for 30 minutes, and washed again with enough water to be neutral. Then, the substrates were ultrasonically cleaned in sequence with methanol, a solution of methanol/toluene (1:1=V/V) and toluene, each for 5 minutes. Finally, the substrates were dried under vacuum, thus hydroxylated substrates are obtained.

Step 2: Amination of the Hydroxylated Substrates

The hydroxylated substrates obtained in step 1 were placed into a toluene solution containing 1% (V/V) aminopropyl triethoxy silane which is an aminating reagent, and aminated at 25° C. for 40 hours. After the reaction was stopped, the substrates were ultrasonically cleaned in sequence with toluene, a solution of methanol/toluene (1:1=V/V), and methanol at room temperature, each for 5 minutes. After cleaning, the substrates were heated at 120° C. under vacuum for 60 minutes, thereafter cooled slowly to room temperature. Then the substrates were ultrasonically cleaned with toluene and methanol for 5 minutes, respectively, and dried under vacuum, thus preliminary aminated substrates were obtained. The substrates were placed into a deionized aqueous solution containing 0.1% CH₃COOH and ultrasonically cleaned at room temperature for 10 minutes, then ultrasonically cleaned twice with deionized water, each time for 5 minutes. Subsequently, the substrates were ultrasonically cleaned with methanol; methanol/toluene (1:1=V/V) and toluene in turn, each for 5 minutes, and dried under vacuum. The amination process was repeated once again to increase the density of amino groups on the substrate surface. The density of amino groups of the substrate being aminated twice (Joong Ho Moon, Jin Ho Kim, Joon Won Park*, Absolute Surface Density of the Amine Group of the Aminosilylated Thin Layers: Ultraviolet-Visible Spectroscopy, Second Harmonic Generation, and Synchrotron-Radiation Photoelectron Spectroscopy Study., Langmuir 1997, 13, 4305-4310) was 40-100 amino groups/nm².
(Joong Ho Moon, Ji Won Shin, Formation of Uniform Aminosilane Thin Layers: An Imine Formation To Measure Relative Surface Density of the Amine Group, Langmuir 1996, 12, 4621-4624)

Step 3: Formation of Mono-Layer Assembled Film with Dianhydride-Type Bi-Functional Monomers on the Surface of the Aminated Substrate

50 mg 3,3′,4,4′-diphenyl ether dianhydride (ODPA) and 10 mg isoquinoline were dissolved in 20.0 ml N,N-dimethylacetamide. An aminated substrate prepared in step 2 was placed therein under the protection of nitrogen gas, and reacted with stirring at 80° C. for 3 hours, then heated slowly to 130° C. and reacted for 12 hours. Thereafter, the substrate was taken out, ultrasonically cleaned with methanol for 3 times, each for 2 minutes, and dried under vacuum, thus a substrate with anhydridised mono-layer film was obtained.

Step 4: Bonding of the Substrate Having Anhydride Groups on its Surface and the Substrate Having Amino Groups on its Surface

The anhydridised substrate obtained in step 3 and another aminated substrate obtained in step 2 were contacted tightly together and put into a jig, and the jig was put into an oven having vacuum degree of 3-10 mmHg. The temperature was raised gradually to 300° C. and kept for 6 hours, then decreased to room temperature at a cooling rate of 15° C./h. After being placed at room temperature for 2 hours, the jig was opened, and a chip with superior bonding effect was obtained. The bonding strength was 30.5 kg/cm².

Dianhydrides list in the following table were used for assembled films to bond substrate, and the above-mentioned processes were repeated. The results were as follows:

| | | Shear |
|---|---|---|
| Compound | | strength |
| (Abbreviation) | Molecular structure | (kg/cm²) |
| Biphenol A diether dianhydride (BPADA) | 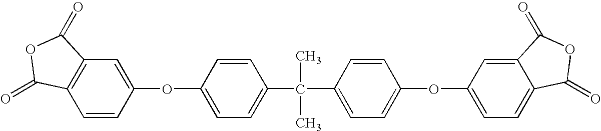 | 25.2 |
| Bi-(trimellitic anhydride) biphenol A diester (BTPDA) | 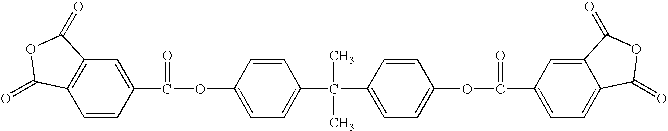 | 26.4 |
| Benzophenone dianhydride (TDA) | 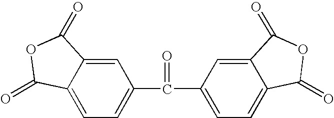 | 17.3 |
| Bi-(trimellitic anhydride) hexafluoro biphenol A diester (6FBDA) | 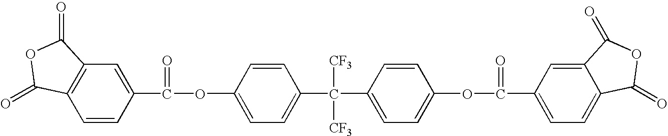 | 26.4 |
| Triphenyl diether dianhydride (HQDPA) | 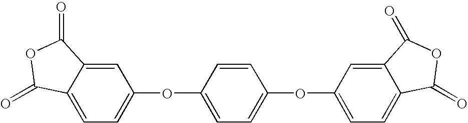 | 28.7 |
| Diphenyl thioether dianhydride (TDPA) | 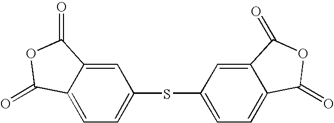 | 24.8 |
| Bi-(trimellitic anhydride)) hydroquinone diester (DEsDA) | 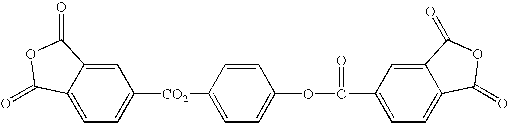 | 28.5 |
| Pyromellitic dianhydride (PMDA) | 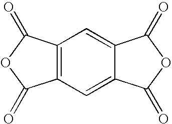 | 12.2 |

### Example 1.2

### AB-Type Bonding of a Substrate with an Assembled Multi-Layer Film Formed by Dianhydride Compounds and an Aminated Substrate

The bonding process of two solid planes in this example comprised four steps. Step 1 was a step of cleaning and hydroxylating of substrates, and step 2 was a step of aminating the hydroxylated substrates, and these two steps were the same as those in Example 1.1. Steps 3 and 4 are as follows:

Step 3: Formation of Multi-Layer Assembled Films with Dianhydride-Type Bi-Functional Monomers and Diamine-Type Bi-Functional Monomers on an Aminated Substrate Surface

40 mg triphenyl ether dianhydride and 10 mg isoquinoline were dissolved in 20.0 ml N,N-dimethylacetamide. The aminated substrate was placed therein under the protection of nitrogen gas, and reacted with stirring at 80° C. for 3 hours, then heated slowly to 130° C. and kept for 8 hours. Thereafter, the substrate was taken out, ultrasonically cleaned with methanol for 3 times, each for 2 minutes, and dried under vacuum, thus a substrate having anhydride groups as terminal groups of the assembled film was obtained. The obtained substrate was placed into a solution of 20 mg ether diamine and 5 mg isoquinoline in 20.0 ml N,N′-dimethylacetamide, and reacted at 70° C. for 5 hours, then heated slowly to 130° C. and kept for 12 hours. Thereafter, the substrate was taken out, ultrasonically cleaned with methanol for 3 times, each for 2 minutes, and dried under vacuum, thus a substrate having an amino group as a terminal group of the assembled film was obtained. A substrate with a multi-layer film having anhydride groups as terminal groups was obtained by repeating the above anhydridising reaction.

Step 4: Bonding of the Substrate Having Anhydride Groups on its Surface and the Aminated Substrate

The substrate having anhydride groups as terminal groups of multi-layer film obtained in step 3 and another aminated substrate obtained in step 2 were contacted tightly together and put into a jig, and the jig was put into a vacuum oven. The temperature was raised gradually to 300° C. and kept for 7 hours, then decreased to room temperature at a cooling rate of 15° C./h. After being placed at room temperature for 2 hours, the jig was opened, and a chip with superior bonding effect was obtained. The bonding strength was 21.2 kg/cm².

### Example 1.3

### Multi-Layer Film Assembled by Dianhydride Compounds on a Substrate, and AB-Type Bonding of a Substrate Having Amino Groups as Terminal Groups of Multi-Layer Film and a Substrate Having Amino Groups as Terminal Groups of multi-layer Film

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of Multi-Layer Assembled Film with Dianhydride-Type Bi-Functional Monomers and Diamine-Type Bi-Functional Monomers on the Surface of the Aminated Substrate

20 mg triphenyl ether dianhydride and 5 mg isoquinoline were dissolved in 20.0 ml N,N-dimethylacetamide. Two aminated substrates were placed therein under the protection of nitrogen gas, and reacted with stirring at 80° C. for 3 hours, then heated slowly to 130° C. and kept for 8 hours. Thereafter, the substrates were taken out, ultrasonically cleaned with methanol for 3 times, each for 2 minutes, and dried under vacuum. Thus two substrates (B) having anhydride groups as terminal groups of the assembled film were obtained. One of the obtained substrate was put into a solution of 20 mg ether diamine and 5 mg isoquinoline in 20.0 ml N,N-dimethylacetamide, and reacted at 70° C. for 5 hours, then heated slowly to 130° C. and kept for 15 hours. Thereafter, the substrate was taken out, ultrasonically cleaned with methanol for 3 times, each for 2 minutes, and dried under vacuum, thus a substrate (A) having amino groups as terminal groups of multi-layer film was obtained.

Step 4: Bonding of the Substrate with a Multi-Layer Film Having Anhydride Groups on its Surface and the Substrate with a Multi-Layer Film Having Amino Groups on its Surface

Substrate B having anhydride groups as terminal groups of multi-layer film obtained in step 3 and the substrate A having amino groups as terminal groups of mono-layer film were contacted tightly together and put into a jig, and the jig was put into a vacuum oven. The temperature was raised gradually to 300° C. and kept for 5 hours, then decreased to room temperature at a cooling rate of 15° C./h, after being placed at room temperature for 2 hours, the jig was opened, and a chip with superior bonding effect was obtained. The bonding strength was 15.4 kg/cm².

According to the same reaction process, a substrate having amino groups at film terminal which was obtained by reacting an anhydridised substrate (with a mono-layer having anhydride groups) with diamine compounds listed in the table below was bonded with another anhydridised substrate (with a mono-layer having anhydride groups). The results were as follows:

| Compound | | Shear strength |
|---|---|---|
| (Abbreviation) | Molecular structure | (kg/cm²) |
| 4,4′-Diamino diphenylmethane (MDA) | 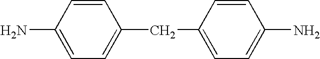 | 15.7 |
| 4,4′-Diamino diphenyl thioether (DABPS) | 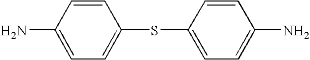 | 16.8 |
| p-phenylenediamine (PPD) | 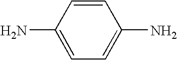 | 10.0 |
| 2,2′-Di[4-(4- aminophenoxy) phenyl]propane (BAPP) | 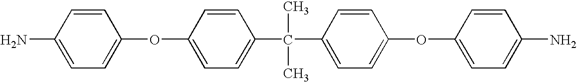 | 15.6 |
| O,o-di(4-aminophenyl) biphenol S (BAPS) | 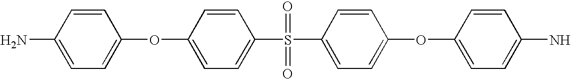 | 14.5 |
| O,o-di(4-aminophenyl) diphenyl ether diphenol (BAPE) | 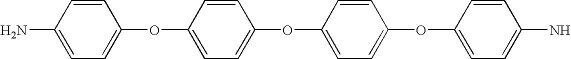 | 17.8 |
| O,o-di(4-aminophenyl) hexafluoro biphenol A (BDAF) | 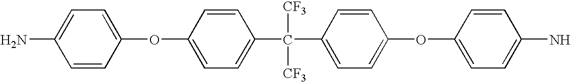 | 17.5 |
| O,o-di(4-aminophenyl) biphenyl diphenol (BAPB) | 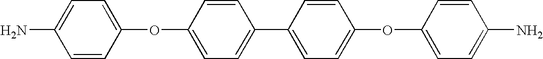 | 12.0 |
| O,o-di(4-aminophenyl) hydroquinone (TPEQ) | 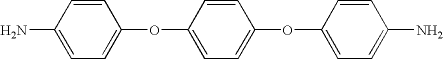 | 16.5 |
| 4,4′-Diamino benzophenone (DABP) | 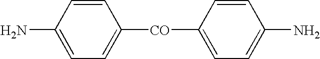 | 8.9 |

### Example 1.4

### A Multi-Layer Film Assembled by Dianhydride and Diamine Compounds on a Substrate, and BB-Type Bonding of Two Substrates Having Anhydride Groups as Terminal Groups of Mono-Layer Film or Multi-Layer Film by Adding a Solution Containing Diamine Molecule Therebetween

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of Multi-Layer Assembled Film with Dianhydride-Type Bi-Functional Monomers and Diamine-Type Bi-Functional Monomers on the Surface of the Aminated Substrate

60 mg triphenyl ether dianhydride and 15 mg isoquinoline were dissolved in 20.0 ml N,N-dimethylacetamide. Two aminated substrates were placed therein under the protection of nitrogen gas, and reacted with stirring at 80° C. for 3 hours, then heated slowly to 130° C. and kept for 8 hours. Thereafter, the substrates were taken out, ultrasonically cleaned with methanol for 3 times, each for 2 minutes, and dried under vacuum, thus two substrates having anhydride groups as terminal groups of the assembled film were obtained. The two substrates were put into a solution of 20 mg triphenyl ether diamine and 5 mg isoquinoline in 20.0 ml N,N-dimethylacetamide, and reacted at 70° C. for 12 hours, then heated slowly to 130° C. and kept for 8 hours. Thereafter, the substrates were taken out, ultrasonically cleaned with methanol for 3 times, each for 1-2 minutes, and dried under vacuum, thus two substrates having amino groups as terminal groups of a multi-layer film were obtained. Two substrates having anhydride groups as terminal groups of a multi-layer film were obtained by repeating the above dianhydridising reaction process.

Step 4: Bonding of Two Substrates Having Anhydride Groups on their Surfaces with a Solution of a Diamine or Polyamine Compound Added Therebetween

A drop of a solution of diphenyl ether diamine in N,N-dimethylacetamide (20 mg/20 ml) was added into the space between the two substrates having anhydride groups as terminal groups of a multi-layer film which were obtained in step 3. The two substrates were contacted tightly together and put into a jig, and the jig was placed into a vacuum oven. The temperature was raised gradually to 300° C. and kept for 3 hours, then decreased to room temperature at a cooling rate of 15° C./h. After being kept at room temperature for 2 hours, the jig was opened, and a chip having superior bonding effect was obtained. The bonding strength was 10.7 kg/cm².

### Example 1.5

### A Multi-Layer Film Assembled by Dianhydride and Diamine Compounds on a Substrate, and AA-Type Bonding of Two Substrates Both Having Amino Groups as Terminal Groups of Mono-Layer Film or Multi-Layer Film by Adding a Solution Containing Dianhydride Molecule Therebetween

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of a Multi-Layer Assembled Film with a Dianhydride-Type Bi-Functional Monomer and a Diamine-Type Bi-Functional Monomer on the Surface of the Aminated Substrate

30 mg triphenyl ether dianhydride and 5 mg isoquinoline were dissolved in 20.0 ml N,N-dimethylacetamide. Two aminated substrates were put therein under the protection of nitrogen gas, and reacted at 80° C. with stirring for 3 hours, then heated slowly to 130° C. and kept for 8 hours. Thereafter, the substrates were taken out, ultrasonically cleaned with methanol for 3 times, each for 2 minutes, and dried under vacuum, thus two substrates having anhydride groups as terminal groups of the assembled film were obtained. The two substrates were placed again into a solution of 40 mg triphenyl ether diamine and 10 mg isoquinoline in 20.0 ml N,N-dimethylacetamide, and reacted at 70° C. for 8 hours, then heated slowly to 130° C. and kept for 12 hours. Thereafter, the substrates were taken out, ultrasonically cleaned with methanol for 3 times, each for 1 minute, and dried under vacuum, thus two substrates having amino groups as terminal groups of a multi-layer film were obtained. Two substrates having amino groups as terminal groups of a multi-layer film were obtained by repeating the above reaction with dianhydride and diamine compounds.

Step 4: Bonding of Two Substrates Having Amino Groups on their Surfaces with a Solution of a Dianhydride Compound Added Therebetween

A drop of a solution of diphenyl ether dianhydride in N,N-dimethylacetamide (20 mg/20 ml) was added into the space between the two substrates having amino groups as terminal groups of a multi-layer film which were obtained in step 3. The two substrates were contacted tightly together and put into a special jig, then placed into a vacuum oven. The temperature was raised gradually to 300° C. and kept for 6 hours, then decreased to room temperature at a cooling rate of 15° C./h. After being kept at room temperature for 2 hours, the jig was opened, and a chip having superior bonding effect was obtained. The bonding strength was 16.5 kg/cm².

### Example 1.6

### Direct AA-Type Bonding of Two Aminated Substrates with a Solution Containing Dianhydride Molecule Added Therebetween

The bonding process of two solid planes in this example comprised three steps. Step 1 was a step of cleaning and hydroxylating of substrates, and Step 2 was a step of aminating the hydroxylated substrates, and these two steps were the same as those in Example 1.1. Step 3 was a step of bonding two aminated substrates with a dianhydride solution added therebetween.

The detail description of step 3 was as follows:

A drop of a solution of diphenyl ether dianhydride in N,N-dimethylacetamide (20 mg/20 ml) was added into the space between the two aminated substrates. The two substrates were contacted tightly together and put into a jig, and then put into a vacuum oven. The temperature was raised gradually to 300° C. and kept for 5 hours, then decreased to room temperature at a cooling rate of 15° C./h. After being placed at room temperature for 5 hours, the jig was opened, thus a chip having superior bonding effect was obtained. The bonding strength was 10 kg/cm².

### Example 2

Methods of Bonding Two Solid Planes with Urea Linkages Formed by Reacting Diisocyanate-Type Bi-Functional Compounds with Amino Groups

The materials for bonding in these examples were silicon plate, quartz plate or glass plate. The bonding reactions could be performed between two solid planes made of the same materials or different materials, and the shear strengths of the bonded solid planes were similar.

### Example 2.1

### AB-Type Bonding of a Substrate with an Assembled Mono-Layer Film Formed by Diisocyanate and an Aminated Substrate

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of Mono-Layer Assembled Film with Diisocyanate-Type Bi-Functional Monomers on Aminated Substrate Surface

40 mg 4,4′-diisocyanate diphenyl methane (MDI) were dissolved in 20.0 ml N,N-dimethylacetamide. An aminated substrate prepared in step 2 was placed therein under the protection of nitrogen gas, and reacted with stirring at 60° C. for 3 hours, then heated slowly to 130° C. and kept for 12 hours. Thereafter, the substrate was taken out, ultrasonically cleaned with acetone for 3 times, each for 2 minutes, and dried under vacuum, thus a substrate having isocyanate groups as terminal groups of a mono-layer on its surface was obtained.

Step 4: Bonding of the Substrate Having Isocyanate Groups on its Surface and the Surface-Aminated Substrate

The substrate having isocyanate groups on its surface and the surface-aminated substrate obtained in step 2 were contacted tightly together and put into a jig, and the jig was put into a vacuum oven. The temperature was raised gradually to 300° C. and kept for 5 hours, then decreased to room temperature at a cooling rate of 15° C./h. After being placed at room temperature for 2 hours, the jig was opened, and a chip with superior bonding effect was obtained. The bonding strength was 35.2 kg/cm².

A substrate having an assembled mono-layer film formed by other diisocyanate compounds was bonded with the aminated substrate, according to the above reaction processes, and the results were as follows:

| | | Shear |
|---|---|---|
| | | strength |
| Compounds Name | Molecular structure | (kg/cm²) |
| 1-Isocyanate-4-(4-isocyanate phenoxy) benzene | 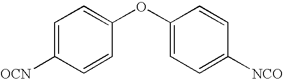 | 25.0 |
| 3,3′-Dimethoxy-4,4′-biphenyl diisocyanate | 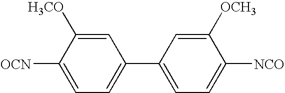 | 24.3 |
| 3,3′-Dimethyl-4,4′-biphenyl diisocyanate | 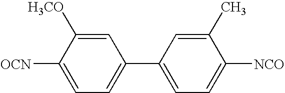 | 25.4 |
| 3,3′-Dimethyl diphenyl methane-4,4′-diisocyanate | 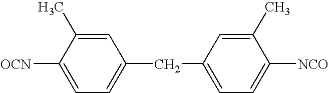 | 31.5 |
| 3,3′-Dimethoxy diphenyl methane-4,4′-diisocyanate | 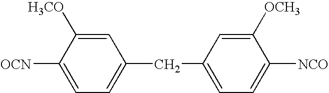 | 32.1 |
| Diphenylmethane-4,4′-diisocyanate (MDI) | 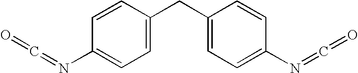 | 35.3 |
| 2-Chloro-4-(3-chloro-4-isocyanate benzyl)-1-isocyanate benzene | 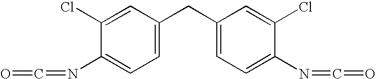 | 21.4 |
| 5-(3,5-Diethyl-4-isocyanate benzyl)-1,3-diethyl-2-isocyanate benzene | 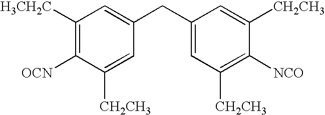 | 19.7 |
| 2,5-Diisocyanate toluene | 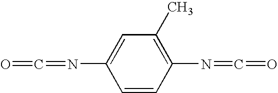 | 15.5 |
| 2,4-Diisocyanate toluene | 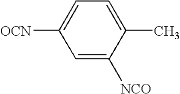 | 12.0 |

### Example 2.2

### AB-Type Bonding of a Substrate with an Assembled Multi-Layer Film Formed by Diisocyanate-Type Monomers and an Aminated Substrate

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of Multi-Layer Assembled Films with Diisocyanate-Type Bi-Functional Monomers and Diamine-Type Bi-Functional Monomers on the Surface of the Aminated Substrate

50 mg 4,4′-diisocyanate phenyl methane (MDI) were dissolved in 20.0 ml N,N-dimethylacetamide. The aminated substrate was placed therein under the protection of nitrogen gas, and reacted with stirring at 60° C. for 3 hours, then heated slowly to 100° C. and reacted for 8 hours. Thereafter, the substrate was taken out, ultrasonically cleaned with acetone for 3 times, each for 2 minutes, and dried under vacuum, thus an anhydridised substrate was obtained. The substrate was put again into a solution of diphenyl ether diamine in N,N-dimethylacetamide (20 mg/20 ml) under the protection of nitrogen gas, and taken out after reacting at 100° C. for 12 hours, then ultrasonically cleaned with acetone for 3 times, each for 2 minutes, and dried under vacuum, thus a substrate having amino groups as terminal groups on its surface was obtained. A substrate with a multi-layer film having isocyanate groups as terminal groups was obtained by repeating the above reaction with MDI.

Step 4: Bonding of the Substrate Having Isocyanate Groups on its Surface and the Aminated Substrate

The substrate with a multi-layer film having isocyanate groups as terminal groups obtained in step 3 and an aminated substrate obtained in step 2 were contacted tightly together and put into a jig, and the jig was put into a vacuum oven. The temperature was raised gradually to 300° C. and kept for 5 hours, then decreased to room temperature at a cooling rate of 15° C./h. After being placed at room temperature for 2 hours, the jig was opened, and a chip with superior bonding effect was obtained. The bonding strength was 30.8 kg/cm².

### Example 2.3

### Multi-Layer Film Assembled by Diisocyanate-Type Compounds on a Substrate, and AB-Type Bonding of a Substrate Having Amino Groups as Terminal Groups of Multi-Layer Film and a Substrate Having Isocyanate Groups as Terminal Groups of Multi-Layer Film

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of Multi-Layer Assembled Film with Diisocyanate-Type Bi-Functional Monomers and Diamine-Type Bi-Functional Monomers on the Surface of the Aminated Substrate

80 mg 4,4′-diisocyanate phenyl methane (MDI) were dissolved in 20.0 ml N,N-dimethylacetamide. Two aminated substrates were placed therein under the protection of nitrogen gas, and reacted with stirring at 60° C. for 3 hours, then heated slowly to 100° C. and reacted for 8 hours. Thereafter the substrates were taken out, ultrasonically cleaned with acetone for 3 times, each for 2 minutes, and dried under vacuum, thus two anhydridised substrates were obtained. One of the two substrates was put again into diphenyl ether diamine in N,N-dimethylacetamide solution (40 mg/20 ml), and reacted at 100° C. under the protection of nitrogen gas for 12 hours, then ultrasonically cleaned with acetone for 3 times, each for 2 minutes, and dried under vacuum, thus a substrate (A) having amino groups on its surface was obtained. Another substrate was reacted with MDI repeatedly, thus a substrate (B) having isocyanate groups as terminal groups of a multi-layer film was formed.

Step 4: Bonding of the Substrate with a Multi-Layer Film Having Isocyanate Groups on its Surface and a Substrate with the Multi-Layer Film Having Amino Groups on its Surface

The substrate (B) having isocyanate groups as terminal groups of a multi-layer film and the substrate (A) having amino groups as terminal groups of a multi-layer film obtained in step 3 were contacted tightly together and put into a jig, then placed into a vacuum oven. The temperature was raised gradually to 300° C. and kept for 5 hours, then decreased to room temperature at a cooling rate of 15° C./h. After being placed at room temperature for 2 hours, the jig was opened, and a chip with superior bonding effect was obtained. The bonding strength was 21.4 kg/cm².

### Example 2.4

### A Multi-Layer Film Assembled by Diisocyanate-Type and Diamine- or Polyamine-Type Compounds, and BB-Type Bonding of Two Substrates Both Having Anhydride Groups as Terminal Groups of Mono-Layer Film or Multi-Layer Film by Adding a Solution Containing Diamine Molecule Therebetween

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of a Multi-Layer Assembled Film with Diisocyanate-Type Compound Monomers on the Surface of the Aminated Substrate

70 mg 4,4′-diisocyanate phenyl methane (MDI) were dissolved in 20.0 ml N,N-dimethylacetamide. Two aminated substrates were placed therein under the protection of nitrogen gas, and reacted with stirring at 60° C. for 3 hours, then heated slowly to 100° C. and reacted for 8 hours. Thereafter, the substrates were taken out, ultrasonically cleaned with acetone for 3 times, each for 2 minutes, and dried under vacuum, thus anhydridised substrates were obtained. The substrates were put again into a solution of diphenyl ether diamine in N,N-dimethylacetamide (40 mg/20 ml), and taken out after reacting at 100° C. under the protection of nitrogen gas for 12 hours, then ultrasonically cleaned with acetone for 3 times, each for 2 minutes, and dried under vacuum, thus substrates having amino groups on their surfaces were obtained. The substrates were reacted with MDI repeatedly, thus substrates having isocyanate groups as terminal groups of multi-layer films were obtained.

Step 4: Bonding of Two Substrates Both Having Isocyanate Groups on their Surfaces with a Solution of a Diamine or Polyamine Added Therebetween

A drop of a solution of diphenyl ether diamine in N,N-dimethylformamide (20 mg/20 ml) was added into the space between two substrates having isocyanate groups as terminal groups of multi-layer films obtained in step 3, then the two substrates were contacted tightly together and put into a jig, and placed into a vacuum oven. The temperature was raised gradually to 300° C. and kept for 6 hours, then decreased to room temperature at a cooling rate of 15° C./h. After being placed at room temperature for 2 hours, the jig was opened, and a chip with superior bonding effect was obtained. The bonding strength was 12.6 kg/cm².

### Example 2.5

### A Multi-Layer Film Assembled by Diisocyanate-Type and Diamine-Type Compounds on a Substrate, and AA-Type Bonding of Two Substrates Both Having Amino Groups as Terminal Groups of a Mono-Layer Film or Multi-Layer Film by Adding a Solution Containing Diisocyanate Molecule Therebetween

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of a Mono-Layer or Multi-Layer Assembled Film with a Diisocyanate-Type Bi-Functional Monomer on the Surface of the Aminated Substrate

60 mg 4,4′-diisocyanate phenyl methane (MDI) were dissolved in 20.0 ml N,N-dimethylacetamide. Two aminated substrates were placed therein under the protection of nitrogen gas, and reacted with stirring at 60° C. for 3 hours, then heated slowly to 100° C. and reacted for 8 hours. Thereafter, the substrates were taken out, ultrasonically cleaned with acetone for 3 times, each for 2 minutes, and dried under vacuum, thus anhydridised substrates were obtained. The substrates were put again into a solution of 30 mg diphenyl ether diamine in 20 ml N,N-dimethylacetamide, and taken out after reacting at 100° C. under the protection of nitrogen gas for 12 hours, ultrasonically cleaned with acetone for 3 times, each for 2 minutes, and dried under vacuum, thus substrates having amino groups on their surfaces were obtained.

Step 4: Bonding of Two Substrates Both Having Amino Groups on their Surfaces with a Solution of a Diisocyanate Monomer Added Therebetween

A drop of a solution of 4,4′-diisocyanate phenyl methane (MDI) in N,N-dimethylacetamide (20 mg/20 ml) was added into the space between two substrates both having amino groups as terminal groups of a multi-layer film obtained in step 3. The two substrates were contacted tightly together and put into a jig, then heated in a vacuum oven. The temperature was raised gradually to 300° C. and kept for 5 hours, then decreased to room temperature at a cooling rate of 15° C./h. After being placed at room temperature for 2 hours, the jig was opened, and a chip with superior bonding effect was obtained. The bonding strength was 12 kg/cm².

### Example 2.6

### Direct AA-Type Bonding of Two Aminated Substrates with a Solution Containing Diisocyanate-Type Monomers Added Therebetween

The bonding process of two solid planes in this example comprised three steps. Step 1 was a step of cleaning and hydroxylating of substrates, and Step 2 was a step of aminating the hydroxylated substrates, therein these two steps were the same as those in Example 1.1. Step 3 was described as follows:

A drop of a solution of 4,4′-diisocyanate phenyl methane (MDI) in N,N-dimethylacetamide (20 mg/20 ml) was added into the space between two aminated substrates obtained in step 2. The two substrates were contacted tightly together and put into a jig, then heated in a vacuum oven. The temperature was raised gradually to 300° C. and kept for 4 hours, then decreased to room temperature at a cooling rate of 15° C./h. After having been kept at room temperature for 2 hours, the jig was opened, and a chip having superior bonding effect was obtained. The bonding strength was 12.1 kg/cm².

### Example 3

Methods of Bonding Two Solid Planes with Amide Linkages Formed by Reacting Diacyl Halide-Type Bi-Functional Compounds with Amino Groups

The materials for bonding in these examples were silicon plate, quartz plate or glass plate. The bonding reactions could be performed between two solid planes made of the same materials or different materials, and the shear strengths of the bonded solid planes were similar.

### Example 3.1

### An AB-Type Bonding of a Substrate with an Assembled Mono-Layer Film Formed by Diacyl Chloride and an Aminated Substrate

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of Mono-Layer Assembled Film with Diacyl Chloride-Type Bi-Functional Monomers on the Surface of the Aminated Substrate

Into a solution containing 0.5 ml triethylamine and 0.5 ml dimethylpyridine in 20.0 ml dichloromethane, an aminated substrate was placed therein under the protection of nitrogen gas, and 5.0 ml biphenyl di-formyl chloride were added dropwise over 15 minutes. The mixture was reacted with stirring under reflux for 24 hours. Thereafter the substrate was taken out, and ultrasonically cleaned with dichloromethane for 3 times, each for 2 minutes, and dried under vacuum, thus a substrate with an acylated surface was obtained.

Step 4: Bonding of the Substrate Having Acyl Chloride Groups on its Surface and the Substrate Having Amino Groups on its Surface

The acylated substrate obtained in step 3 and an aminated substrate obtained in step 2 were contacted tightly together and put into a jig, then heated in a vacuum oven. The temperature was raised gradually to 300° C. and kept for 5 hours, then decreased to room temperature at a cooling rate of 15° C./h. After being placed at room temperature for 2 hours, the jig was opened, and a chip with superior bonding effect was obtained. The bonding strength was 15 kg/cm².

A substrate having an assembled mono-layer film formed by other diacyl chloride compounds was bonded with the aminated substrate, according to the above reaction processes, and the results were as follows:

| | | Shear strength |
|---|---|---|
| Compounds Name | Molecular structure | (kg/cm²) |
| Terephthaloyl chloride | 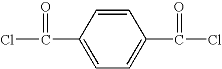 | 11.5 |
| Isophthaloyl chloride | 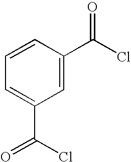 | 5.0 |
| Octanedioyl chloride | 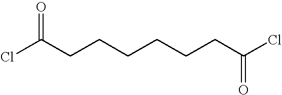 | 15.2 |

### Example 3.2

### AB-Type Bonding of a Substrate with an Assembled Multi-Layer Film Formed by Diacyl Chloride-Type Monomers and an Aminated Substrate

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of Multi-Layer Assembled Films with Diacyl Chloride-Type Monomers and Diamine-Type Bi-Functional Monomers on the Surface of the Aminated Substrate

1.0 ml dimethylpyridine and 1.0 ml triethylamine were dissolved in 20.0 ml dichloromethane. An aminated substrate was placed therein under the protection of nitrogen gas, and 10.0 ml terephthaloyl chloride was added dropwise over 15 minutes. The mixture was reacted with stirring under reflux for 24 hours. Thereafter, the substrate was taken out, and ultrasonically cleaned with dichloromethane for 3 times, each for 1 minute, and dried under vacuum, thus an acylated substrate was obtained. The substrate was put again into a solution of 30 mg 4,4′-diphenyl ether diamine in 20 ml dichloromethane (containing 1.0 ml triethylamine and 0.5 ml dimethylpyridine), and reacted under reflux at 40° C. for 10 hours. Thereafter, the substrate was taken out, and ultrasonically cleaned with dichloromethane for 3 times, each for 2 minutes, then dried under vacuum, thus a substrate having amino groups on its surface was obtained. This substrate was reacted with terephthaloyl chloride repeatedly, thus a substrate having acyl chloride groups as terminal groups of an assembled film was obtained.

Step 4: Bonding of the Substrate Having Acyl Chloride Groups on its Surface and the Aminated Substrate

The substrate having acyl groups as terminal groups of a multi-layer film obtained in step 3 and the aminated substrate obtained in step 2 were contacted tightly together and put into a jig, then heated in a vacuum oven. The temperature was raised gradually to 300° C. and kept for 4 hours, then decreased to room temperature at a cooling rate of 15° C./h. After being placed at room temperature for 2 hours, the jig was opened, and a chip with superior bonding effect was obtained. The bonding strength was 15 kg/cm².

### Example 3.3

### A Multi-Layer Film Assembled by Diacyl Chloride-Type Compounds on a Substrate, and AB-Type Bonding of a Substrate Having Amino Groups as Terminal Groups of Multi-Layer Film and a Substrate Having Acyl Chloride Groups as Terminal Groups of Multi-Layer Film

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of a Multi-Layer Assembled Film with Diacyl Chloride Monomers and Diamine Monomers on the Surface of the Aminated Substrate

0.5 ml dimethylpyridine and 1.0 ml triethylamine were dissolved in 20.0 ml dichloromethane. Two aminated substrates were placed therein under the protection of nitrogen gas, and 5.0 ml terephthaloyl chloride was added dropwise over 15 minutes. The mixture was reacted with stirring under reflux for 24 hours. Thereafter, the substrates were taken out, and ultrasonically cleaned with dichloromethane for 3 times, each for 1-2 minutes, and dried under vacuum, thus two acylated substrates were obtained. One substrate of the two was put again into a solution of 40 mg 4,4′-diphenyl ether diamine in 20 ml dichloromethane (containing 1.0 ml triethylamine and 0.5 ml dimethylpyridine), and reacted under reflux at 40° C. for 10 hours. Thereafter, the substrate was taken out, and ultrasonically cleaned with dichloromethane for 3 times, each for 2 minutes, and dried under vacuum, thus a substrate (A) having amino groups on its surface was obtained. Another substrate was reacted with terephthaloyl chloride repeatedly, thus a substrate (B) having acyl chloride groups as terminal groups of the assembled film was obtained.

Step 4: Bonding of the Substrate with a Multi-Layer Film Having Acyl Chloride Groups on its Surface and the Substrate with a Multi-Layer Film Having Amino Groups on its Surface

The substrate (B) having acyl chloride groups as terminal group of the assembled film and the substrate (A) having amino groups as terminal groups of a multi-layer assembled film obtained in step 3 were contacted tightly together, and put into a special jig, then heated in a vacuum oven. The temperature was raised gradually to 300° C. and kept for 4 hours, then decreased to room temperature at a cooling rate of 15° C./h. After being placed at room temperature for 2 hours, the jig was opened, and a chip with superior bonding effect was obtained. The bonding strength was 11.5 kg/cm².

### Example 3.4

### A Substrate with a Multi-Layer Film Assembled by Diacyl Chloride-Type and Diamine- or Polyamine-Type Compounds, and BB-Type Bonding of Two Substrates Both Having Diacyl Chloride Groups as Terminal Groups of a Mono-Layer Film or Multi-Layer Film by Adding a Solution Containing Diamine Molecule Therebetween

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of a Mono-Layer or Multi-Layer Assembled Film with a Diacyl Chloride-Type Compound and a Diamine-Type Compound Monomer on the Surface of the Aminated Substrate

1.0 ml dimethylpyridine and 1.0 ml triethylamine were dissolved in 20.0 ml dichloromethane. Two aminated substrates were placed therein under the protection of nitrogen gas, then 5.0 ml terephthaloyl chloride were added dropwise over 15 minutes. The mixture was reacted with stirring under reflux for 24 hours. Thereafter, the substrate was taken out, and ultrasonically cleaned with dichloromethane for 3 times, each for 1-2 minutes, and dried under vacuum, thus acylated substrates were obtained. The substrates were put again into a solution of 50 mg 4,4′-diphenyl ether diamine in 20 ml dichloromethane (containing 1.0 ml triethylamine and 0.5 ml dimethylpyridine), and reacted under reflux at 40° C. for 10 hours. Thereafter, the substrates were taken out, and ultrasonically cleaned with dichloromethane for 3 times, each for 2 minutes, and dried under vacuum, thus substrates having amino groups on their surfaces were obtained. The substrates having acyl chloride groups as terminal groups of the assembled film were obtained by reacting the above substrates with terephthaloyl chloride repeatedly.

Step 4: Bonding of Two Substrates Each with a Multi-Layer Film Having Acyl Chloride Groups on its Surface with a Solution of a Diamine or Polyamine Compound Added Therebetween

A drop of a solution of ether diamine in N,N-dimethylacetamide (20 mg/20 ml) which contained 1.0 ml triethylamine and 0.5 ml dimethylpyridine was added into the space between the two substrates having acyl chloride groups as terminal groups of the assembled film obtained in step 3. The two substrates were contacted tightly together and put into a jig, then heated in a vacuum oven. The temperature was raised gradually to 300° C. and kept for 4 hours, then decreased to room temperature at a cooling rate of 15° C./h. After being placed at room temperature for 2 hours, the jig was opened, thus a chip having superior bonding effect was obtained. The bonding strength was 5.0 kg/cm².

### Example 3.5

### A Multi-Layer Film Assembled by Diacyl Chloride-Type and Diamine-Type Compounds on a Substrate, and AA-Type Bonding of Two Substrates Both Having Amino Groups as Terminal Groups of a Mono-Layer Film or Multi-Layer Film by Adding a Solution of Diacyl Chloride Monomer Therebetween

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of a Mono-Layer or Multi-Layer Assembled Film with a Diacyl Chloride-Type Monomer and a Diamine-Type Compound Monomer on the Surface of the Aminated Substrate

1.0 ml dimethylpyridine and 1.0 ml triethylamine were dissolved in 20.0 ml dichloromethane. Two aminated substrates were placed therein under the protection of nitrogen gas, and 5.0 ml terephthaloyl chloride was added dropwise over 15 minutes. The mixture was reacted under reflux with stirring for 24 hours. Thereafter the substrate was taken out, and ultrasonically cleaned with dichloromethane for 3 times, each for 1 minute, and dried under vacuum, thus acylated substrates were obtained. The substrates were put again into a solution of 30 mg 4,4′-diphenyl ether diamine in 20 ml dichloromethane (containing 1.0 ml triethylamine and 1.0 ml dimethylpyridine), and reacted at 40° C. under reflux for 10 hours. Thereafter the substrates was taken out, and ultrasonically cleaned with dichloromethane for 3 times, each for 2 minutes, and dried under vacuum, thus substrates having amino groups on their surfaces were obtained.

Step 4: Bonding of Two Substrates Both Having Amino Groups on their Surfaces with a Solution of a Diacyl Chloride Monomer Added Therebetween

A drop of a solution of terephthaloyl chloride in dichloromethane (2 ml/20 ml) was added into the space between two substrates both having amino groups as terminal groups of a multi-layer film obtained in step 3. The two substrates were contacted tightly together and put into a jig, then heated in a vacuum oven. The temperature was raised gradually to 300° C. and kept for 6 hours, then decreased to room temperature at a rate of 15° C./h, after being placed at room temperature for 2 hours, the jig was opened, and a chip with superior bonding effect was obtained. The bonding strength was 6.5 kg/cm².

### Example 3.6

### A Direct AA-Type Bonding of Two Aminated Substrates with a Solution of a Diacyl Chloride-Type Monomer Added Therebetween

The bonding process of two solid planes in this example comprised three steps. Step 1 was a step of cleaning and hydroxylating of substrates, and Step 2 was a step of aminating the hydroxylated substrates, these two steps were same as that of Example 1.1. Step 3 was a step of bonding two aminated substrates with a diacyl chloride monomer solution added therebetween; the detail description was as follows:

A drop of a solution of terephthaloyl chloride in dichloromethane (2 ml/20 ml, containing 1.0 ml triethylamine and 0.5 ml dimethylpyridine) was added into the space between the two aminated substrates. The two substrates were contacted tightly together and put into a jig, then put into a vacuum oven. The temperature was raised gradually to 300° C. and kept for 6 hours, then decreased to room temperature at a cooling rate of 15° C./h. After being placed at room temperature for 2 hours, the jig was opened, thus a chip having superior bonding effect was obtained. The bonding strength was above 6.1 kg/cm².

### Example 4

Bonding of Solid Planes with Schiff Base Linkages Formed by Reacting Dialdehyde-Type Bi-Functional Compounds as Assembling Molecule with Amino Groups

The materials for bonding in these examples were silicon plate, quartz plate or glass plate. The bonding reactions could be performed between two solid planes made of the same materials or different materials, and the shear strengths of bonded solid planes were similar.

### Example 4.1

### AB-Type Bonding of a Substrate with an Assembled Mono-Layer Film Formed by Dialdehyde and an Aminated Substrate

The bonding process of two solid planes in this example comprised four steps. Step 1 was a step of cleaning and hydroxylating of substrates, and Step 2 was a step of aminating the hydroxylated substrates, these two steps were same as that of Example 1.1. Steps 3 and 4 were as follows:

Step 3: Formation of a Mono-Layer Assembled Film with Dialdehyde-Type Bi-Functional Monomers on an Aminated Substrate Surface

40 mg 4,4′-dialdehyde-1,1′-diphenyl methane were dissolved in 20.0 ml tetrahydrofuran, and then 0.5 g Linder 4 \acute{Å} molecular sieve and 10.0 μL acetic acid were added. Two aminated substrates obtained in step 2 were placed therein under the protection of nitrogen gas, and reacted with stirring under reflux at about 70° C. for 8 hours. Thereafter, the substrates were taken out, ultrasonically cleaned with acetone for 3 times, each for 1 minute, and dried under vacuum, thus substrates with a mono-layer assembled film having aldehyde groups on its surface.

Step 4: Bonding of the Substrate Having Aldehyde Groups on its Surface and the Substrate Having Amino Groups on its Surface

The substrate having aldehyde groups on its surface obtained in step 3 and the aminated substrate obtained in step 2 were contacted tightly together and put into a jig, and heated in a vacuum oven. The temperature was raised gradually to 250° C. and kept for 5 hours, then decreased to room temperature at a cooling rate of 15° C./h. After being placed at room temperature for 2 hours, the jig was opened, thus a chip having superior bonding effect was obtained. The bonding strength was 9.8 kg/cm².

Other dialdehyde compounds were used for assembling mono-layer films and bonding with an aminated substrate, according to the above reaction processes. The results were as follows:

| | | Shear |
|---|---|---|
| | | strength |
| Compounds | Molecular structure | (kg/cm²) |
| Terephthalic aldehyde | 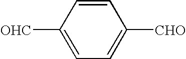 | 8.9 |
| Isophthalic aldehyde | 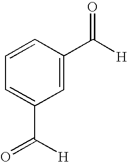 | 6.8 |
| 1,1′-Biphenyl-3,4′- dicarbaldehyde | 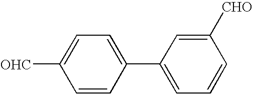 | 14.3 |
| 1,1′-Biphenyl-4,4′- dicarbaldehyde | 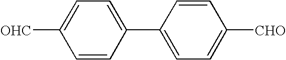 | 12.4 |
| 4,4′-Di-formyl-1,1′-diphenyl methane | 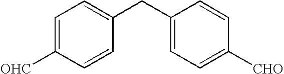 | 15.0 |
| 1-Formyl-4-(4-formyl phenoxy) benzene | 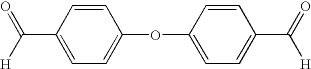 | 13.2 |

### Example 4.2

### AB-Type Bonding of a Substrate with an Assembled Multi-Layer Film Formed by Dialdehyde-Type Monomers and an Aminated Substrate

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of Multi-Layer Assembled Films with Dialdehyde-Type Monomers and Diamine-Type Monomers on the Surface of the Aminated Substrate

50.0 mg biphenyl dicarbaldehyde were dissolved in 20.0 ml tetrahydrofuran. Into this solution, 0.5 g Linder 4 \acute{Å} molecular sieve and 10.0 μL acetic acid were added. Then, two aminated substrates were placed therein under the protection of nitrogen gas and reacted with stirring under reflux at 70° C. for 8 hours. Thereafter, the substrates were taken out, ultrasonically cleaned with acetone for 3 times, each for 2 minutes, and dried under vacuum, thus acylated substrates were obtained. The substrates were put again into a solution of 40 mg 4,4′-diphenyl ether diamine in 20.0 ml tetrahydrofuran, and 0.5 g Linder 4 \acute{Å} molecular sieve and 10.0 μL acetic acid were added, and reacted with stirring under reflux at 70° C. under the protection of nitrogen gas for 8 hours. Thereafter, the substrates were taken out, ultrasonically cleaned with methanol for 3 times, each for 1 minute, and dried under vacuum, thus substrates with a multi-layer film having amino groups on its surfaces were obtained. The substrates with a multi-layer film having aldehyde group as terminal groups were obtained by repeating the above acylated process.

Step 4: Bonding of the Substrate Having Aldehyde Groups on its Surface and the Aminated Substrate

The substrate with a multi-layer film having aldehyde group as terminal groups obtained in step 3 and another aminated substrate obtained in step 2 were contacted tightly together, and put into a jig, then heated in a vacuum oven. The temperature was raised gradually to 250° C. and kept for 5 hours, then decreased to room temperature at a cooling rate of 15° C./h. After being placed at room temperature for 2 hours, the jig was opened, and a chip with superior bonding effect was obtained. The bonding strength was 8.3 kg/cm².

### Example 4.3

### A Multi-Layer Film Assembled by Dialdehyde-Type Compounds on a Substrate, and AB-Type Bonding of a Substrate Having Amino Groups as Terminal Groups of Multi-Layer Film and a Substrate Having Aldehyde Groups as Terminal Groups of Multi-Layer Film

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of a Multi-Layer Assembled Film with a Dialdehyde-Type Monomer and a Diamine-Type Monomer on the Surface of the Aminated Substrate

60 mg biphenyl dicarbaldehyde were dissolved in 20.0 ml tetrahydrofuran, and 0.5 g Linder 4 \acute{Å} molecular sieve and 10.0 μL acetic acid were added. Two aminated substrates were added therein under the protection of nitrogen gas. The substrates were taken out after being reacted with stirring under reflux at 70° C. for 8 hours, then ultrasonically cleaned with acetone for 3 times, each for 2 minutes, and dried under vacuum, thus acylated substrates (B) were obtained. One of the two substrates was put into a solution of 50 mg 4,4′-diphenyl ether diamine in 20.0 ml tetrahydrofuran to which 0.5 g Linder 4 \acute{Å} molecular sieve, 10.0 μL acetic acid were further added, then reacted with stirring under reflux at 70° C. under the protection of nitrogen gas for 8 hours. Thereafter the substrate was taken out, ultrasonically cleaned with methanol for 3 times, each for 1 minute, and dried under vacuum, thus a substrate (A) with a multi-layer film having amino groups on its surface was obtained.

Step 4: Bonding of the Substrate with a Multi-Layer Film Having Aldehyde Groups on its Surface and the Substrate with a Multi-Layer Film Having Amino Groups on its Surface

The substrate (B) with a multi-layer film having aldehyde groups on its surface and the substrate (A) with a multi-layer film having amino groups on its surface obtained in step 3 were contacted tightly together and put into a jig, then heated in a vacuum oven. The temperature was raised gradually to 250° C. and kept for 4 hours, then decreased to room temperature at a cooling rate of 15° C./h. After being placed at room temperature for 2 hours, the jig was opened, and a chip with superior bonding effect was obtained. The bonding strength was 6.3 kg/cm².

### Example 4.4

### A Multi-Layer Film Assembled by a Dialdehyde-Type Compound and a Diamine- or Polyamine-Type Compound, and BB-Type Bonding of Two Substrates Both Having Aldehyde Groups as Terminal Groups of Mono-Layer Film or Multi-Layer Film by Adding a Solution Containing Diamine Molecule Therebetween

The bonding process of two solid planes in this example comprised four steps. Step 1 was a step of cleaning and hydroxylating of substrates, and step 2 was a step of aminating the hydroxylated substrates, and these two steps were the same as those in Example 1.1. Steps 3 and 4 were as follows:

Step 3: Formation of a Multi-Layer Assembled Film with a Dialdehyde-Type Monomer and a Diamine-Type Monomer on the Surface of the Aminated Substrate

40 mg biphenyl dicarbaldehyde were dissolved in 20.0 ml tetrahydrofuran, and then 0.5 g Linder 4 \acute{Å} molecular sieve and 10.0 μL acetic acid were added. Two aminated substrates were added therein under the protection of nitrogen gas. The substrates were taken out after being reacted with stirring under reflux at 70° C. for 8 hours, then ultrasonically cleaned with acetone for 3 times, each for 2 minutes, and dried under vacuum, thus acylated substrates were obtained. The substrates were placed into 20.0 ml tetrahydrofuran solution containing 40 mg 4,4′-diphenyl ether diamine to which 0.5 g Linder 4 \acute{Å} molecular sieve and 10.0 μL acetic acid were further added, then reacted with stirring under reflux at 70° C. under the protection of nitrogen gas for 8 hours. Thereafter, the substrates were taken out, ultrasonically cleaned with methanol for 3 times, each for 1 minute, and dried under vacuum, thus substrates with a multi-layer film having amino groups on its surface were obtained. The substrates having aldehyde groups as terminal groups of a multi-layer film were obtained by repeating the reaction with biphenyl dicarbaldehyde.

Step 4: Bonding of Two Substrates Both Having Aldehyde Groups on their Surfaces with a Solution of a Diamine or Polyamine Compound Added Therebetween

A drop of a solution of triphenyl ether diamine in N,N-dimethylacetamide (20 mg/20 ml) was added into the space between two substrates having aldehyde groups as terminal groups of multi-layer films obtained in step 3, then the two substrates were contacted tightly together and put into a jig, and heated in a vacuum oven. The temperature was raised gradually to 250° C. and kept for 5 hours, then decreased to room temperature at a cooling rate of 15° C./h. After being placed at room temperature for 2 hours, the jig was opened, and a chip with superior bonding effect was obtained. The bonding strength was 7.5 kg/cm².

### Example 4.5

### A Multi-Layer Film Assembled by a Dialdehyde-Type Compound and a Diamine-Type Compound on a Substrate, and AA-Type Bonding of Two Substrates Both Having Amino Groups as Terminal Groups of a Mono-Layer Film or Multi-Layer Film by Adding a Solution Containing a Dialdehyde Monomer Therebetween

The bonding process of two solid planes in this example comprised four steps. Step 1 was a step of cleaning and hydroxylating of substrates, and Step 2 was a step of aminating the hydroxylated substrates, and these two steps were the same as those in Example 1.1. Steps 3 and 4 were as follows:

Step 3: Formation of a Multi-Layer Assembled Film with a Dialdehyde-Type Monomer and a Diamine-Type Monomer on an Aminated Substrate Surface

30 mg biphenyl dicarbaldehyde was dissolved in 20.0 ml tetrahydrofuran, and then 0.5 g Linder 4 \acute{Å} molecular sieve and 10.0 μL acetic acid were added. Two aminated substrates were added therein under the protection of nitrogen gas, and then reacted with stirring under reflux at 70° C. for 8 hours. Thereafter, the substrates were taken out, ultrasonically cleaned with acetone for 3 times, each for 2 minutes, and dried under vacuum, thus acylated substrates were obtained. The substrates were placed into 30.0 ml tetrahydrofuran solution containing 20 mg 4,4′-diphenyl ether diamine to which 0.5 g Linder 4 \acute{Å} molecular sieve and 10.0 μL acetic acid were added, then reacted with stirring under reflux at 70° C. under the protection of nitrogen gas for 8 hours. Thereafter the substrates were taken out, ultrasonically cleaned with methanol for 3 times, each for 1 minute, and dried under vacuum, thus substrates with a multi-layer film having amino groups on its surface were obtained.

Step 4: Bonding of Two Substrates Both Having Amino Groups on their Surfaces with a Solution of a Dialdehyde Monomer Added Therebetween

A drop of a solution of biphenyl dicarbaldehyde in tetrahydrofuran solution (10 mg/20 ml) was added into the space between the two substrates having amino groups as terminal groups of multi-layer films obtained in step 3, and then the two substrates were contacted tightly together and put into a jig, and heated in a vacuum oven. The temperature was raised gradually to 250° C. and kept for 5 hours, then decreased to room temperature at a cooling rate of 15° C./h. After being placed at room temperature for 2 hours, the jig was opened, and a chip with superior bonding effect was obtained. The bonding strength was 5.7 kg/cm².

### Example 4.6

### Direct AA-Type Bonding of Two Aminated Substrates with a Solution Containing a Dialdehyde-Type Monomer Added Therebetween

The bonding process of two solid planes in this example comprised three steps. Step 1 was a step of cleaning and hydroxylating of substrates, and Step 2 was a step of aminating the hydroxylated substrates, and these two steps were the same as those in Example 1.1. Step 3 was described as follows:

A drop of a solution of biphenyl dicarbaldehyde in tetrahydrofuran solution (10 mg/20 ml) was added into the space between the two aminated substrates. The two substrates were contacted tightly together and put into a jig, then heated in a vacuum oven. The temperature was raised gradually to 200° C. and kept for 10 hours, then decreased to room temperature at a rate of 15° C./h. After being placed at room temperature for 5 hours, the jig was opened, thus a chip having superior bonding effect was obtained. The bonding strength was 4.6 kg/cm².

We claim:

1. A method for bonding two solid planes via surface assembling of active functional groups, including the steps of:
(1) Cleaning the solid planes having silicon, oxygen or metal elements of substrates, and hydroxylating the solid planes to form hydroxyl groups thereon;
(2) Reacting the hydroxyl groups on the solid planes with an amino siloxane reagent to form amino groups on the solid planes;
(3) forming a mono-layer assembled film by the reaction of a compound monomer having an active bi-functional or multi-functional group with the amino groups on the solid planes; or forming bi-layer assembled film by the reaction of the mono-layer assembled film with a diamine or polyamine monomer, or forming multi-layer assembled film by repeating the above reactions,
(4) contacting two solid planes with assembled films having same or different active functional groups on their surfaces; and adding a solution containing another compound monomer having an active bi-functional or multi-functional group which can react with the functional group on the solid plane into the space between the two solid planes when the molecular films having the same active functional groups; and then reacting under the conditions of a temperature of 100-400° C. and a vacuum of less than 10 mmHg for 3-10 hours,
Wherein in the above-mentioned step (3),
The compound monomer having an active bi-functional or multi-functional group is any one selected from group consisting of compounds of I, II, III or IV types:
I. Anhydride-type compounds comprising mainly compounds each having two or more anhydride groups in a molecule;
II. Isocyanate-type compounds comprising mainly compounds each having two or more isocyanate groups in a molecule;
III. Acyl halide-type compounds comprising mainly compounds each having two or more acyl halide groups in a molecule; and
IV. aldehyde-type compounds comprising mainly compounds each having two or more aldehyde groups in a molecule;
The diamine or polyamine compounds comprise mainly compounds each having two or more amino groups in a molecule,
H₂N—R—NH₂
wherein R in the above-mentioned formula may be a molecular chain containing aromatic, aliphatic, cyclic or heterocyclic groups; and X is a halogen of F, Cl, Br or I;
The reaction of a compound monomer having an active bi-functional or multi-functional group with the amino groups on the solid planes is a solid-liquid reaction which is carried out in a solvent in the presence of a catalyst, wherein the solvent and catalyst are selected as follows:
With respect to the anhydride-type compounds, the solvent is selected mainly from N,N′-dimethylformamide, N,N′-dimethylacetamide, cresol, m-cresol, p-chlorophenol or N-methylpyrrolidone, and the catalyst is isoquinoline or triethylamine with a molar ratio of 0.5-1.0 to the monomer;
With respect to the isocyanate-type compounds, the solvent is selected mainly from N,N′-dimethylformamide or N,N′-dimethylacetamide;
With respect to the aldehyde-type compounds, the solvent is selected mainly from methanol, ethanol, tetrahydrofuran, N,N′-dimethylformamide or N,N′-dimethylacetamide, and the catalyst is acetic acid or formic acid with a volume ratio of 0.01-0.5% to the solvent; and
With respect to the diacyl chloride-type compounds, the solvent is selected mainly from dichloromethane, chloroform, toluene, benzene or carbon tetrachloride, and the catalyst is triethylamine, pyridine, N-methylpyridine or N,N′-dimethylpyridine with a volume ratio of 1-5% to the solvent.

2. The method for bonding two solid planes via surface assembling of active functional groups according to claim 1, wherein a solid-solid reaction between the solid planes with assembled monolayer molecular films, bi-layer molecular films or multi-layer molecular films having different active functional groups on film surfaces is taking place in the step (4), resulting in the formation of covalent bonds between the two solid planes, thus achieving a stable AB type bonding at molecular level,
wherein the AB type bonding refers to a type of bonding wherein the active functional groups assembled in the surfaces of two substrates used in the bonding are different, the terminal group carried by the film of one substrate is amino group, and the terminal group carried by the film of another substrate is any of anhydride group, aldehyde group, acyl halide group or isocyanate group, and the two substrates are contacted and press-bonded directly without any substance interposed therebetween, thereby a bonding is carried out.

3. The method for bonding two solid planes via surface assembling of active functional groups according to claim 1, wherein a solid-liquid reaction between the two solid planes having amino groups on film surfaces and a solution containing another active bi-functional or multi-functional compound monomer which can react with amino group interposed therebetween is taking place in the step (4), resulting in the formation of covalent bonds between the two solid planes, thus achieving a stable AA type bonding at molecular level,
wherein the AA type bonding refers to a type of bonding wherein the active functional groups assembled in the surfaces of two substrates used in the bonding are amino groups, and the solid planes are bonding with a solution interposed therebetween, wherein the solution contains a compound having bi-functional group or multi-functional group capable of reacting with amino group such as dianhydride, diacyl halide, dialdehyde or diisocyanate.

4. The method for bonding two solid planes via surface assembling of active functional groups according to claim 1, wherein a solid-liquid reaction between the two solid planes having the same active functional groups capable of reacting with amino group amino groups on film surfaces and a solution containing a diamine or polyamine compound monomer interposed therebetween is taking place in the step (4), resulting in the formation of covalent bonds between the two solid planes, thus achieving a stable BB type bonding at molecular level,
wherein the BB type bonding refers to a type of bonding wherein the active functional groups assembled in the surfaces of two substrates used in bonding are all groups that can react with amino group comprising anhydride group, aldehyde group, acyl halide group or isocyanate group, and the solid planes are bonding with a solution of a diamine or a polyamine interposed therebetween.

5. The method for bonding two solid planes via surface assembling of active functional groups according to claim 1, wherein the solid planes having silicon, oxygen or metal elements in step (1) comprise solid plane or wafer made of single crystal silicon, silicon oxide, metal elements-doped chemical modified silicon oxide, quartz or glass with a flat surface.

6. The method for bonding two solid planes via surface assembling of active functional groups according to claim 1, wherein the surface roughness of the solid plane is in a range of 1 nm-20 nm.

7. The method for bonding two solid planes via surface assembling of active functional groups according to claim 1, wherein the reaction temperature is 50-200° C. in the case where the compound monomer having an active bi-functional or multi-functional group in the step (3) is the anhydride-type compound.

8. The method for bonding two solid planes via surface assembling of active functional groups according to claim 1, wherein the reaction temperature is 50-160° C. in the case where the compound monomer having an active bi-functional or multi-functional group in the step (3) is the isocyanate-type compound.

9. The method for bonding two solid planes via surface assembling of active functional groups according to claim 1, wherein the reaction temperature is 40-100° C. in the case where the compound monomer having an active bi-functional or multi-functional group in the step (3) is the aldehyde-type compound.

10. The method for bonding two solid planes via surface assembling of active functional groups according to claim 1, wherein the reaction temperature is 20-100° C. in the case where the compound monomer having an active bi-functional or multi-functional group in the step (3) is the diacyl chloride-type compound.

11. The method for bonding two solid planes via surface assembling of active functional groups according to claim 1, wherein the temperature is 250-350° C. in the step (4).

12. The method for bonding two solid planes via surface assembling of active functional groups according to claim 1, wherein covalent bonds are formed in the step (4), which comprise an amide linkage, an urea linkage, an imine linkage or an imide linkage.
